(19) United States
(12) Patent Application Publication
(10) Pub. No.: US 2017/0090389 A1
(43) Pub. Date: Mar. 30, 2017

(54) IMAGE FORMING APPARATUS

(71) Applicant: Konica Minolta, Inc., Tokyo (JP)

(72) Inventor: MIKIHIRO YAMAKAWA, Tokyo (JP)

(21) Appl. No.: 15/263,854

(22) Filed: Sep. 13, 2016

(30) Foreign Application Priority Data
Sep. 29, 2015 (JP) 2015-191523

(51) Int. Cl. G03G 15/00

(52) U.S. Cl. CPC G03G 15/6567

(57) ABSTRACT

An image forming apparatus includes: a registration roller pair that conveys paper; a moving mechanism that moves the registration roller pair in an axial direction orthogonal to a paper conveyance direction while the paper is held between the registration roller pair; an adjustment unit that adjusts a nip load of the registration roller pair; and a control unit that controls the adjustment unit, wherein the control unit controls the adjustment unit to satisfy a relationship of [a nip load of the registration roller pair at the time of paper edge alignment in which a skew of paper is corrected by striking a leading edge of the paper against the registration roller pair]>[a nip load of the registration roller pair at the time of reconveying the paper by the registration roller pair]>0.

### CROSS REFERENCE TO RELATED APPLICATIONS

The entire disclosure of Japanese Patent Application No. 2015-191523 filed on Sep. 29, 2015 including description, claims, drawings, and abstract are incorporated herein by reference in its entirety.

### BACKGROUND OF THE INVENTION

Field of the Invention

The present invention relates to an image forming apparatus.

Description of the Related Art

Image forming apparatuses such as a printer and a copier employing electrophotography have been widely used. In a general image forming apparatus, paper is sometimes offset in a direction orthogonal to a conveyance direction or conveyed in a skewed manner due to factors such as various types and properties of paper being used, characteristics of a part such as a conveyance roller, and a use environment such as temperature and humidity at the time of conveyance. The accuracy of a print position is degraded when printing is performed under such conditions.

Accordingly, what is called registration rocking correction is performed to adjust a positional relationship between an image and the paper by sensing the amount of shift of the paper in a paper width direction with an offset sensor and moving the paper in the paper width direction on the basis of a sensing result while press-contacting (holding) the paper with a registration roller pair. Also performed is registration loop correction which corrects a skew of the paper by striking a leading edge of the paper against the registration roller pair. There is disclosed in JP 2011-102184 A, for example, an image forming apparatus which adjusts the paper to an image position by traversing the registration roller pair in a roller shaft direction with use of a rack and a pinion.

However, the image forming apparatus disclosed in JP 2011-102184 A has the following problems. That is, as the image forming apparatus in JP 2011-102184 A supports thicker paper, the rigidity of the paper causes an increase in a conveying load. Accordingly, as for a rocking mechanism, an increase in a rocking load causes a skew or offset shift of the paper. As for a conveying mechanism, the conveying load increased by the rigidity of the paper results in an insufficient conveying force to cause a shift in a lead edge timing and/or a double height. Moreover, a torque of forcedly opening the rollers at a registration nip point is increased due to the increased paper thickness, so that the conveying load at the time of restarting the registration is increased to increase a load on a conveying motor.

As measures to solve these problems, a nip load of the registration roller pair can be increased or the diameters of a registration roller shaft and a driven roller shaft can be increased with increased deflection of the registration roller shaft. This allows the rocking mechanism to overcome the conveying load of the paper and prevent the offset shift and skew of the paper. However, an inertial load at the time of rocking is also increased to decrease a torque margin of a rocking motor, so that a loss of synchronization of the rocking motor causes the offset shift. The aforementioned measures are effective for the conveying force of the conveying mechanism during conveyance, where the mechanism can overcome the conveying load to be able to prevent a shift at the time of conveying the paper. However, the torque of forcedly opening the registration rollers at the nip point is increased at the time of registration re-conveyance to decrease the torque margin of the conveying motor, whereby a loss of synchronization of the conveying motor and jamming cannot be prevented.

### SUMMARY OF THE INVENTION

The present invention has been made in view of the aforementioned problems, and an object of the present invention is to provide an image forming apparatus capable of ensuring necessary conveying force and holding force even when the registration rocking correction or the like with the thick paper is performed.

To achieve the abovementioned object, according to an aspect, an image forming apparatus reflecting one aspect of the present invention comprises: a registration roller pair that conveys paper; a moving mechanism that moves the registration roller pair in an axial direction orthogonal to a paper conveyance direction while the paper is held between the registration roller pair; an adjustment unit that adjusts a nip load of the registration roller pair; and a control unit that controls the adjustment unit, wherein the control unit controls the adjustment unit to satisfy a relationship of [a nip load of the registration roller pair at the time of paper edge alignment in which a skew of paper is corrected by striking a leading edge of the paper against the registration roller pair]>[a nip load of the registration roller pair at the time of reconveying the paper by the registration roller pair]>0.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating an example of the configuration of an image forming apparatus according to a first embodiment of the present invention;

FIG. 2 is a diagram illustrating an example of the configuration of a registration unit;

FIG. 3 is a diagram illustrating an example of the configuration of the registration unit including a backup member;

FIG. 4 is a diagram illustrating an example of the configuration of the registration unit including the backup member;

FIG. 5 is a diagram illustrating an example of the configuration of a rocking mechanism;

FIGS. 6A and 6B are diagrams each illustrating an example of the operation of a pressing/separation mechanism;

FIG. 7 is a diagram illustrating an example of the configuration of a principal part of the backup member;

FIG. 8 is a diagram illustrating an example of the configuration of the registration unit including another backup member;

FIG. 9 is a diagram illustrating an example of the configuration of the registration unit including the other backup member;

FIG. 10 is a diagram illustrating an example of the configuration of a principal part of the other backup member;

FIG. 11 is a block diagram illustrating an example of the functional configuration of the image forming apparatus;

FIG. 12 is a flowchart illustrating an example of the operation of the image forming apparatus at the time of image formation;

FIG. 13 is a diagram illustrating an example of a timing chart of the image forming apparatus at the time of image formation;

FIG. 14 is a diagram illustrating an example of the configuration of a registration unit according to a second embodiment of the present invention;

FIGS. 15A and 15B are diagrams each illustrating an example of the configuration of a pressing/separation mechanism;

FIGS. 16A to 16C are diagrams each illustrating an example of the operation of the pressing/separation mechanism (part one);

FIGS. 17A to 17C are diagrams each illustrating an example of the operation of the pressing/separation mechanism (part two);

FIGS. 18A to 18C are diagrams each illustrating an example of the operation of the pressing/separation mechanism (part three);

FIG. 19 is a flowchart illustrating an example of the operation of the image forming apparatus at the time of image formation;

FIG. 20 is a diagram illustrating an example of a timing chart of the image forming apparatus at the time of image formation;

FIG. 21 is a diagram illustrating an example of the configuration of a registration unit according to a third embodiment of the present invention;

FIG. 22 is a diagram illustrating an example of the configuration of a pressing/separation mechanism;

FIG. 23 is a diagram illustrating an example of the operation of the pressing/separation mechanism (part one);

FIG. 24 is a diagram illustrating an example of the operation of the pressing/separation mechanism (part two); and

FIG. 25 is a diagram illustrating an example of the operation of the pressing/separation mechanism (part three).

### DESCRIPTION OF THE PREFERRED EMBODIMENTS

Hereinafter, preferred embodiments of the present invention will be described in detail with reference to the drawings. However, the scope of the invention is not limited to the illustrated examples. Note that the dimension ratio in the drawings is exaggerated for convenience of explanation and may be different from the actual ratio. Moreover, a movement in a direction orthogonal to a paper conveyance direction D1 is called rocking in some cases.

### First Embodiment

### Example of Configuration of Image Forming Apparatus 100

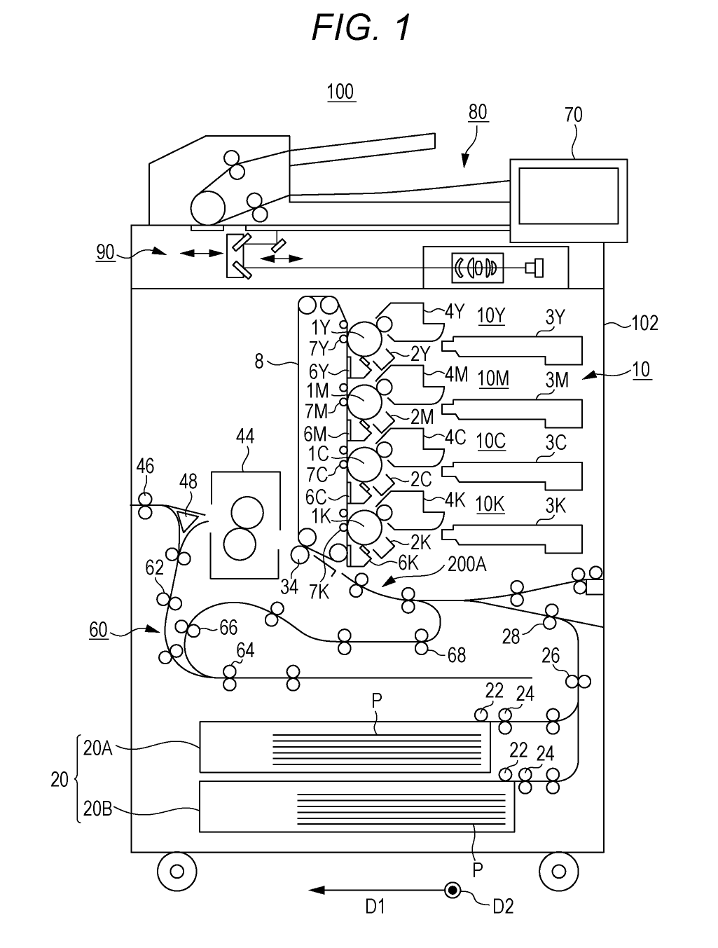

FIG. 1 illustrates an example of the configuration of an image forming apparatus 100 according to the present invention. As illustrated in FIG. 1, the image forming apparatus 100 is what is called a tandem image forming apparatus and includes an automatic document feeder 80 and an apparatus body 102. The automatic document feeder 80 is mounted on top of the apparatus body 102 and uses a conveyance roller or the like to feed paper set on a conveyance stage to an image reading unit 90 of the apparatus body 102.

The apparatus body 102 includes an operation display unit 70, the image reading unit 90, an image forming unit 10, an intermediate transfer belt 8, a paper feeding unit 20, a registration unit 200A, a fixing unit 44, and an auto duplex unit (hereinafter referred to as an ADU) 60.

The operation display unit 70 includes a touch panel formed of a combination of a display unit and an input unit and a plurality of operation keys including a start key and an enter key provided around the touch panel. The operation display unit 70 is adapted to display a menu screen or the like on a screen as well as accept a touch operation on the menu screen and an image forming condition input through the operation key, the condition including information on a paper type such as thick paper.

The image reading unit 90 uses an optical system of a scanning exposure unit to perform scanning exposure on a document placed on a document stage or conveyed by the automatic document feeder 80, then performs a photoelectric conversion on an image of the scanned document with use of a CCD (Charge Coupled Device) image sensor to generate an image information signal. The image information signal is subjected to analog processing, analog/digital (hereinafter referred to as A/D) conversion processing, shading correction, image compression processing and the like by an image processor not shown and thereafter output to the image forming unit 10.

The image forming unit 10 forms an image by electrophotography and includes an image forming unit 10Y that forms an image in yellow (Y), an image forming unit 10M that forms an image in magenta (M), an image forming unit 10C that forms an image in cyan (C), and an image forming unit 10K that forms an image in black (K). In this example, the name of a function common to the colors is denoted by suffixing a corresponding color Y, M, C, or K to be formed to, for example, the reference numeral 10.

The image forming unit 10Y includes a photosensitive drum 1Y as well as a charger 2Y, an exposure unit (optical writing unit) 3Y, a developer 4Y and a cleaning unit 6Y that are disposed around the drum. The image forming unit 10M includes a photosensitive drum 1M as well as a charger 2M, an exposure unit 3M, a developer 4M and a cleaning unit 6M that are disposed around the drum. The image forming unit 10C includes a photosensitive drum 1C as well as a charger 2C, an exposure unit 3C, a developer 4C and a cleaning unit 6C that are disposed around the drum. The image forming unit 10K includes a photosensitive drum 1K as well as a charger 2K, an exposure unit 3K, a developer 4K and a cleaning unit 6K that are disposed around the drum.

Each of the photosensitive drums (image carriers) 1Y, 1M, 1C and 1K, the chargers 2Y, 2M, 2C and 2K, the exposure units 3Y, 3M, 3C and 3K, the developers 4Y, 4M, 4C and 4K, and the cleaning units 6Y, 6M, 6C and 6K has a common configuration among the image forming units 10Y, 10M, 10C and 10K. The letters Y, M, C and K will not be suffixed to the reference numerals unless a distinction is necessary.

The charger 2 charges the surface of the photosensitive drum 1 substantially evenly. The exposure unit 3 is formed of an LPH (LED Print Head) including an LED array and an image forming lens and a laser exposure scanner employing a polygon mirror, for example, and forms an electrostatic latent image by scanning the photosensitive drum 1 with laser light on the basis of the image information signal. The developer 4 develops the electrostatic latent image formed on the photosensitive drum 1 with a toner. As a result, a toner image being a visible image is formed on the photosensitive drum 1.

The intermediate transfer belt 8 is stretched by a plurality of rollers and turnably supported thereby. A primary transfer roller 7 and the photosensitive drum 1 rotate with the turning of the intermediate transfer belt 8, so that a predetermined voltage is applied between the primary transfer roller 7 and the photosensitive drum 1 to transfer the toner image formed on the photosensitive drum 1 onto the intermediate transfer belt 8 (primary transfer).

The paper feeding unit 20 includes a plurality of paper feed trays 20A and 20B in which A3 or A4-size paper P is accommodated. The paper P conveyed by conveyance rollers 22, 24, 26, 28 and the like from each of the paper feed trays 20A and 20B is conveyed to the registration unit 200A. Note that more than or less than two paper feed trays may be included. Moreover, one or a plurality of high-capacity paper feeders that can accommodate a high volume of the paper P may be connected as needed.

The registration unit 200A performs paper edge alignment correction which corrects a skew of paper by striking a leading edge thereof and registration rocking correction which corrects an offset by rocking the paper P in an axial direction D2. The paper P after the skew and offset thereof are corrected is conveyed to a secondary transfer unit 34 at a predetermined timing. In the secondary transfer unit 34, the Y, M, C and K-color toner images transferred onto the intermediate transfer belt 8 are transferred at once to the surface of the paper P conveyed by a registration roller pair 32 (secondary transfer). Following the secondary transfer, the paper P is conveyed to the fixing unit 44 located downstream along a paper conveyance direction D1.

The fixing unit 44 includes a pressure roller and a heating roller. The fixing unit 44 applies pressure and heat to the paper P to which the toner images are transferred in the secondary transfer unit 34, thereby fixing the toner images on the surface of the paper P to the paper P.

Provided downstream of the fixing unit 44 along the paper conveyance direction D1 is a conveyance path switching unit 48 that switches a conveyance path of the paper P to the side of a paper discharge path or the ADU 60. The conveyance path switching unit 48 performs control to switch the conveyance path on the basis of a selected printing mode (a single-sided printing mode, a double-sided printing mode and the like). The paper P completing single-sided printing in the single-sided printing mode or double-sided printing in the double-sided printing mode is discharged to a paper discharge tray by a paper discharge roller 46.

When an image is to be formed on aback side of the paper P in the double-sided printing mode, the paper P is conveyed to the ADU 60 through a conveyance roller 62 and the like after an image is formed on a front side of the paper. On a switchback path of the ADU 60, the paper P is conveyed to a U turn path unit with the rear edge of the paper at the forefront by reverse rotation control of an ADU roller 64, and is fed again to the secondary transfer unit while being flipped by conveyance rollers 66, 68 and the like provided in the U turn path unit.

[Example of Configuration of Registration Unit 200A]

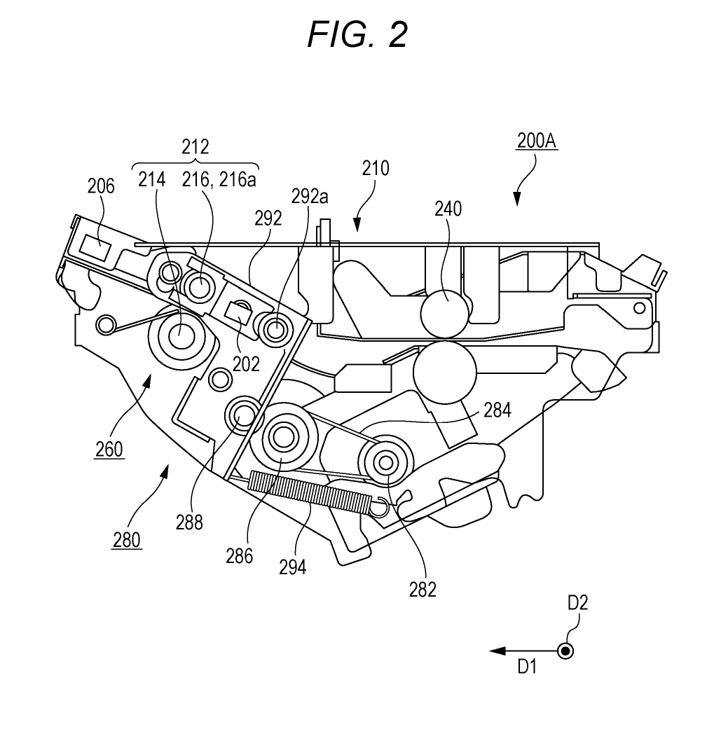

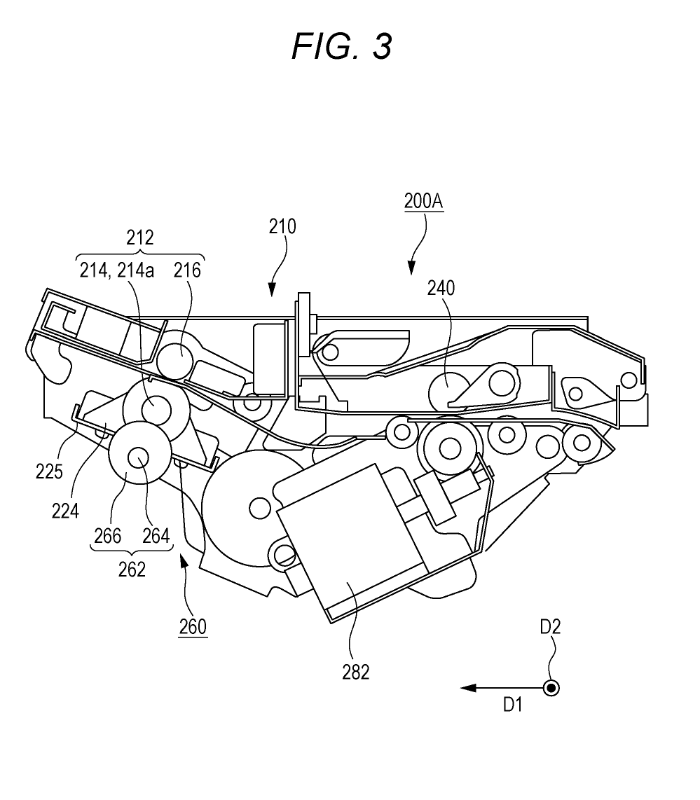

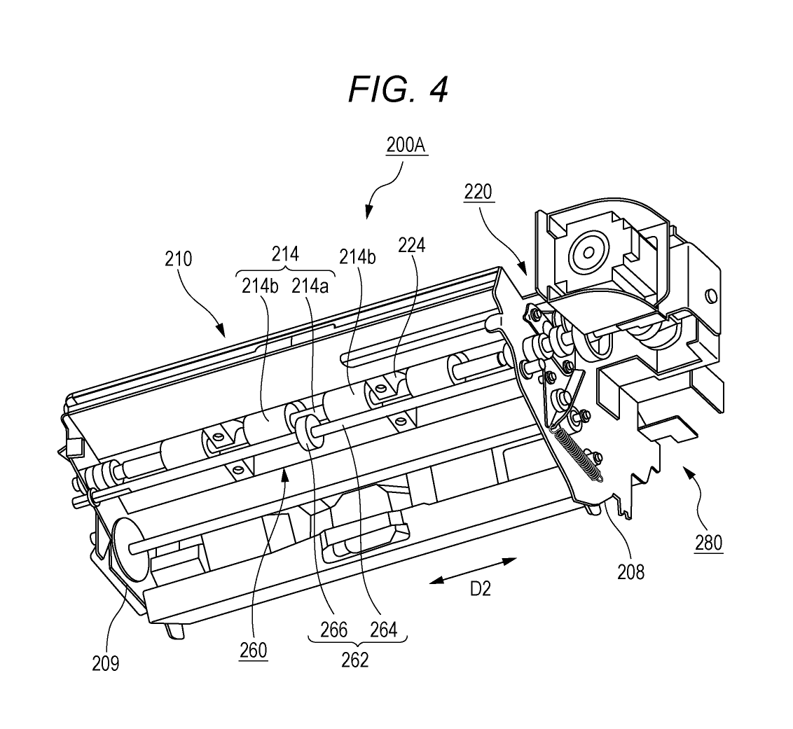

FIG. 2 illustrates an example of the configuration of the registration unit 200A. FIG. 3 illustrates an example of the configuration of the registration unit 200A sectioned at a cross sectional position different from that of FIG. 2. FIG. 4 illustrates an example of the configuration of the registration unit 200A when viewed in the paper conveyance direction D1.

As illustrated in FIGS. 2 to 4, the registration unit 200A includes a conveying mechanism 210, a registration sensor 202, an offset sensor 206, a rocking mechanism (moving mechanism) 220, a nip load adjustment mechanism 260 and a pressing/separation mechanism 280.

The conveying mechanism 210 includes a registration roller pair 212 and a loop roller pair 240. The registration roller pair 212 corrects a skew of the paper P by striking the leading edge thereof, performs correction to align the leading edge of the paper after being re-conveyed with an edge of the image, and corrects an offset of the paper P in a direction (hereinafter referred to as the axial direction D2) orthogonal to the paper conveyance direction D1. The registration roller pair 212 includes a registration roller (driving roller) 214 that performs rotational driving and a driven roller 216 that is driven to rotate with the rotation of the registration roller 214.

The registration roller 214 is formed of a shaft 214a made of SUS or the like and a plurality of rubber rollers 214b attached to the shaft 214a while split at predetermined intervals. Each of both ends of the shaft 214a of the registration roller 214 is rotatably and slidably supported by a bearing provided in each of panels 208 and 209. A support member 224 is fitted to the shaft 214a from above and attached to a plate 225 provided at a lower part of the registration roller 214. The driven roller 216 is disposed to face the registration roller 214 and made of material such as SUS. The driven roller 216 is configured to be pressed against and separated from the registration roller 214 by the pressing/separation mechanism 280.

The loop roller pair 240 is a member that adjusts the amount of the paper P to be fed at the time of creating a loop. The loop roller pair 240 includes a pair of conveyance rollers and is disposed upstream of the registration roller 214 along the paper conveyance direction D1. As with the registration roller 214, the loop roller pair 240 is made of material such as SUS or rubber and configured to be pressed against and separated from each other.

The registration sensor 202 is formed of a light-reflecting or transmitting optical sensor, for example, and is disposed in the conveyance path between the loop roller pair 240 and the registration roller pair 212. The registration sensor 202 is a sensor used to calculate a conveying distance (feed amount) of the paper P at the time of creating a loop and senses the paper P being conveyed.

The offset sensor 206 is formed of a line sensor or the like and disposed downstream of the registration roller pair 212 along the paper conveyance direction D1. The offset sensor 206 is a sensor used to calculate the amount of offset of the paper P in the direction (hereinafter referred to as the axial direction D2) orthogonal to the paper conveyance direction D1 and senses the position of an edge of the conveyed paper P in the axial direction D2.

[Example of Configuration and Operation of Rocking Mechanism 220]

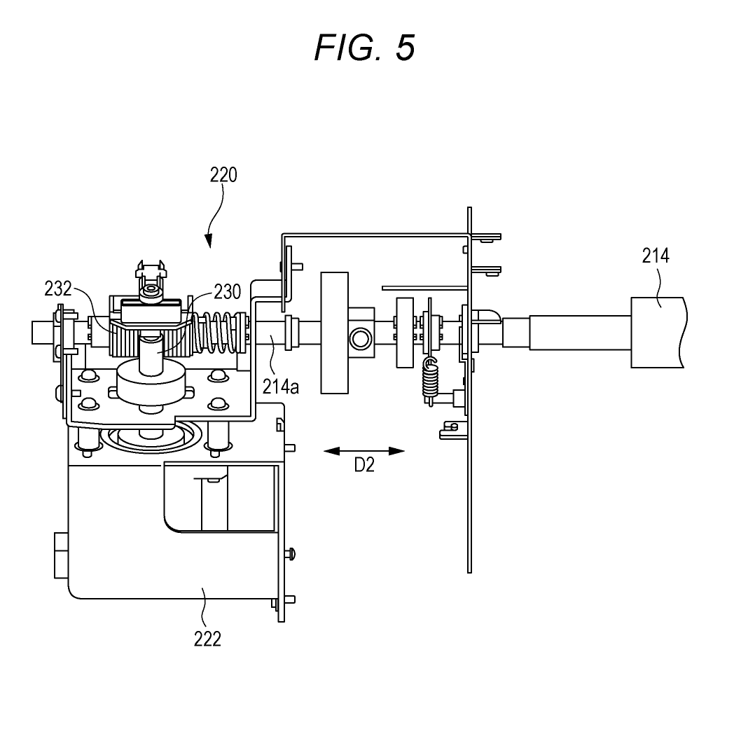

FIG. 5 illustrates an example of the configuration of the rocking mechanism 220. As illustrated in FIG. 5, the rocking mechanism 220 is a mechanism that rocks (moves) the paper P in the axial direction D2 and includes a registration roller rocking motor 222, a pinion gear 230 and a rack 232.

The registration roller rocking motor 222 is formed of a stepping motor or the like to perform rotational drive on the basis of drive control by a control unit to be described. The pinion gear 230 is connected to (in mesh with) a rotary shaft of the registration roller rocking motor 222 to rotate with the driving of the registration roller rocking motor 222. The rack 232 is in mesh with the pinion gear 230 and attached to the shaft 214a of the registration roller 214. The shaft 214a of the registration roller 214 can rotate freely with respect to the rack 232. The rack 232 is also energized inward by a spring not shown.

When the registration roller rocking motor 222 is driven in executing the offset correction, the rocking mechanism 220 is operated such that rotation of the pinion gear 230 causes the rack 232 to rock in the axial direction D2 indicated with an arrow, as illustrated in FIG. 5. The registration roller pair 212 also rocks in the axial direction D2 with the movement of the rack 232 in the axial direction D2.

[Example of Configuration of Pressing/Separation Mechanism 280]

As illustrated in FIG. 2, the pressing/separation mechanism 280 is a mechanism that releases pressing of the registration roller pair 212 and is provided at each of both ends of the driven roller 216. The pressing/separation mechanisms 280 and 280 are connected through a camshaft not shown to operate in conjunction with each other. The pressing/separation mechanisms 280 and 280 having a similar configuration, the configuration of only the pressing/separation mechanism 280 at one end will be described below.

The pressing/separation mechanism 280 includes a driven roller holding member 292, a registration pressing release motor 282, a pressing/separation cam 286, a pressing/separation cam follower 288 and a registration roller pressure spring 294. The driven roller holding member 292 is a plate member having a substantially triangular shape in a planar view, where one end of a rotary shaft 216a of the driven roller 216 is rotatably attached to a corner of the member on the left side in the figure. The driven roller holding member 292 turns according to the angle of rotation of the pressing/separation cam 286 and causes the driven roller 216 to be pressed against or separated from the registration roller 214.

The pressing/separation cam 286 is a disk cam that is connected to the registration pressing release motor 282 via a belt 284 or the like and is driven by the registration pressing release motor 282 to rotate to a predetermined angle of rotation. The pressing/separation cam follower 288 disposed at a position facing the pressing/separation cam 286 is attached to the driven roller holding member 292. When rotating to the predetermined angle of rotation, the pressing/separation cam 286 abuts on (presses) the pressing/separation cam follower 288 to cause the driven roller holding member 292 to turn, with a rotary shaft 292a as a pivot, in a direction in which the driven roller 216 is separated from the registration roller 214

The registration roller pressure spring 294 is formed of a tension spring or the like with one end attached to a lower end face of the driven roller holding member 292 on the side of the registration pressing release motor 282 and another end attached to a body panel not shown. This allows the driven roller holding member 292 to be pulled toward the registration pressing release motor 282 to energize the driven roller 216 toward the registration roller 214.

[Example of Operation of Pressing/Separation Mechanism 280]

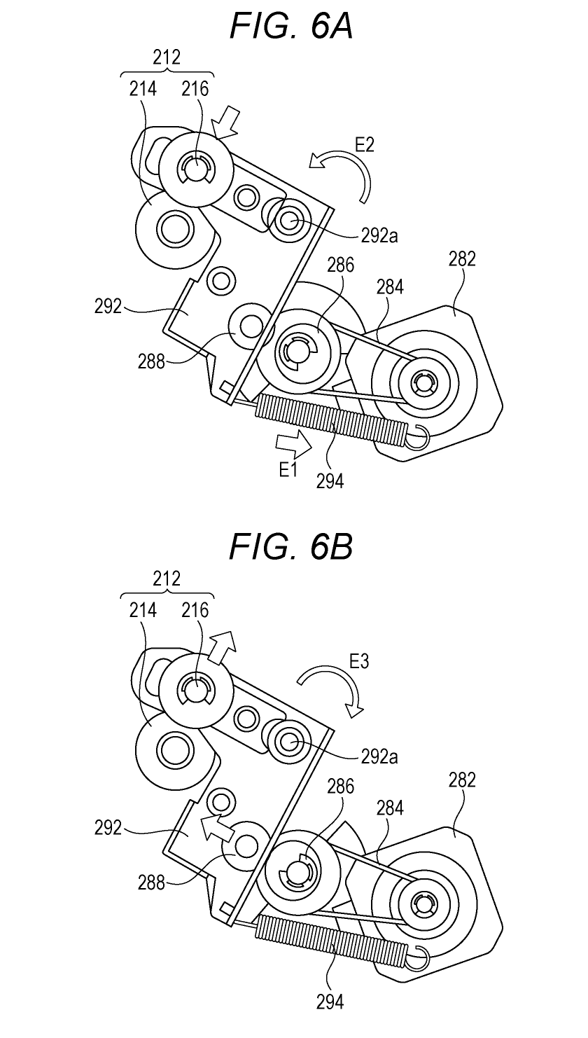

FIG. 6A is a diagram illustrating the operation of the pressing/separation mechanism 280 when the driven roller 216 is pressed against the registration roller 214. FIG. 6B is a diagram illustrating the operation of the pressing/separation mechanism 280 when the driven roller 216 is separated from the registration roller 214.

When the pressing/separation cam follower 288 faces a part of the pressing/separation cam 286 at which the diameter thereof is reduced (the distance from the center to an outer periphery is short), as illustrated in FIG. 6A, a force of the pressing/separation cam 286 does not act on the cam follower since the pressing/separation cam 286 and the pressing/separation cam follower 288 are separated from each other. The driven roller holding member 292 is thus pulled by the registration roller pressure spring 294 in an arrow direction E1 to turn counterclockwise (in an arrow direction E2 in the figure) about the rotary shaft 292a as a pivot. As a result, the driven roller 216 is pressed against the registration roller 214 with a predetermined nip load.

When the pressing/separation cam follower 288 faces a part of the pressing/separation cam 286 at which the diameter thereof is increased (the distance from the center to the outer periphery is long), as illustrated in FIG. 6B, the pressing/separation cam 286 abuts on the pressing/separation cam follower 288 to push up the pressing/separation cam follower 288. The driven roller holding member 292 thus turns clockwise (in an arrow direction E3 in the figure) about the rotary shaft 292a as the pivot with the pressing force of the pressing/separation cam 286. As a result, the driven roller 216 is separated from the registration roller 214.

[Example of Configuration of Nip Load Adjustment Mechanism 260]

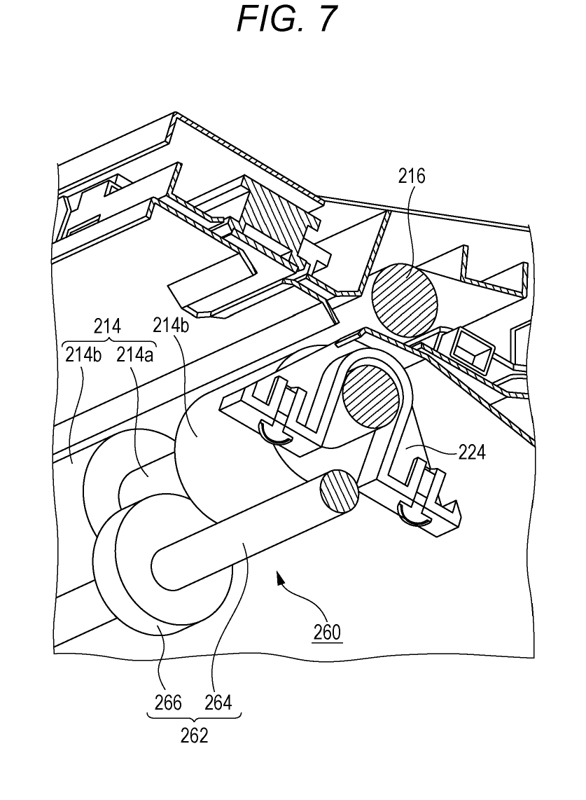

FIG. 7 illustrates an example of the configuration of the nip load adjustment mechanism 260 (backup member 262). The nip load adjustment mechanism 260 is a mechanism that adjusts the nip load of the registration roller pair 212 on the paper P according to paper information such as the thickness and basis weight of the paper P. In the present example, the nip load adjustment mechanism 260 is formed of the backup member 262. The backup member 262 includes a shaft 264 and a deflection preventive cam 266 attached to the shaft 264 as illustrated in FIGS. 3, 4, and 7.

The shaft 264 extends parallel to the shaft 214a of the registration roller 214, where both ends of the shaft 264 are rotatably supported by bearings (not shown) provided in the panels 208 and 209. The shaft 264 is connected to a deflection preventive cam driving motor (not shown) via a gear or the like and rotates with driving of the deflection preventive cam driving motor. The shaft 264 is made of material such as SUS.

The deflection preventive cam 266 is a disk cam that is disposed between the adjacent rubber rollers 214b and 214b of the registration roller 214 and can abut on or separate from the shaft 214a of the registration roller 214 according to an angle of rotation of the deflection preventive cam 266. The deflection preventive cam 266 is disposed at the center of the shaft 264 in its longitudinal direction because the center of the shaft 214a of the registration roller 214 is prone to deflection. Note that while one deflection preventive cam 266 is provided in the present example, a plurality of the deflection preventive cams 266 may be provided as well. Such configuration allows the shaft 214a of the registration roller 214 to be supported more stably.

[Example of Configuration of Backup Member 272]

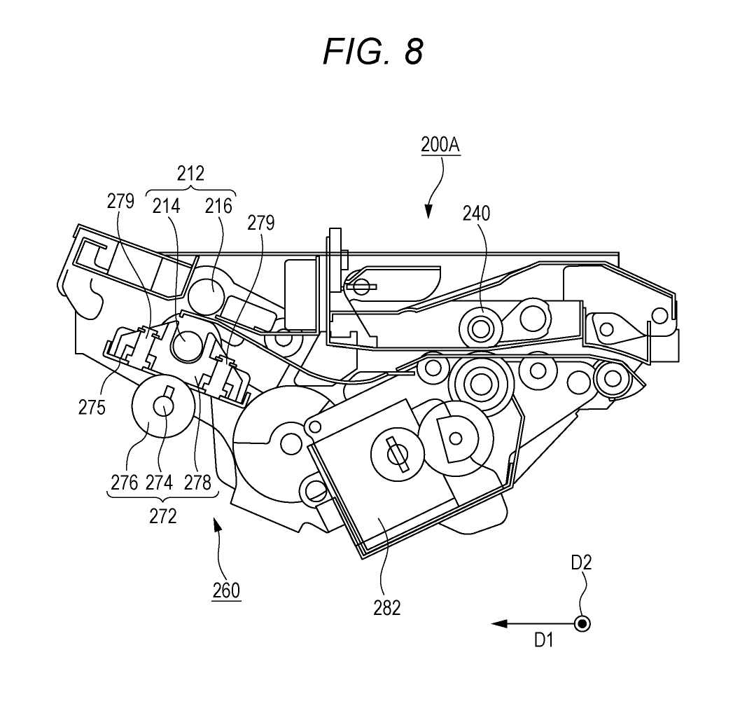

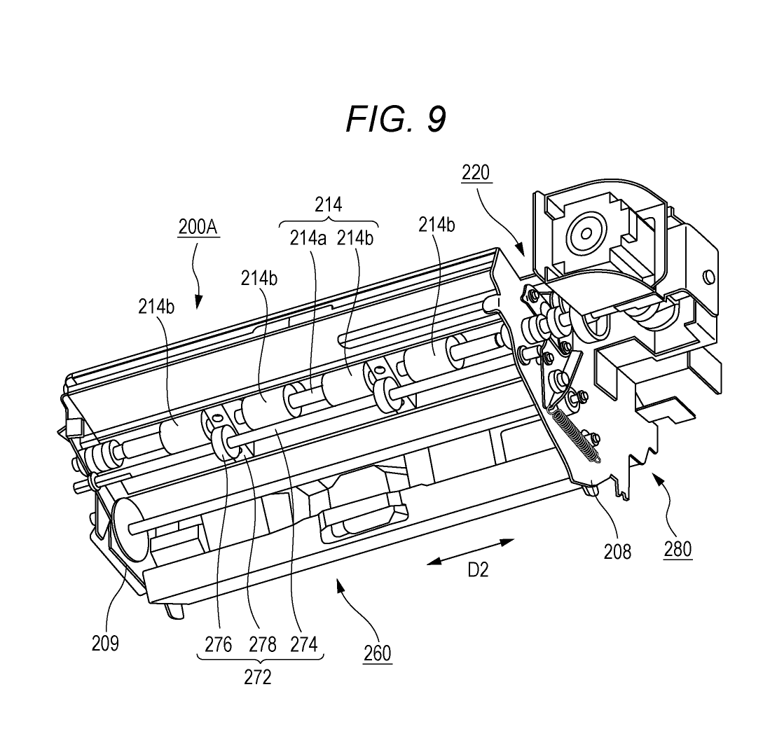

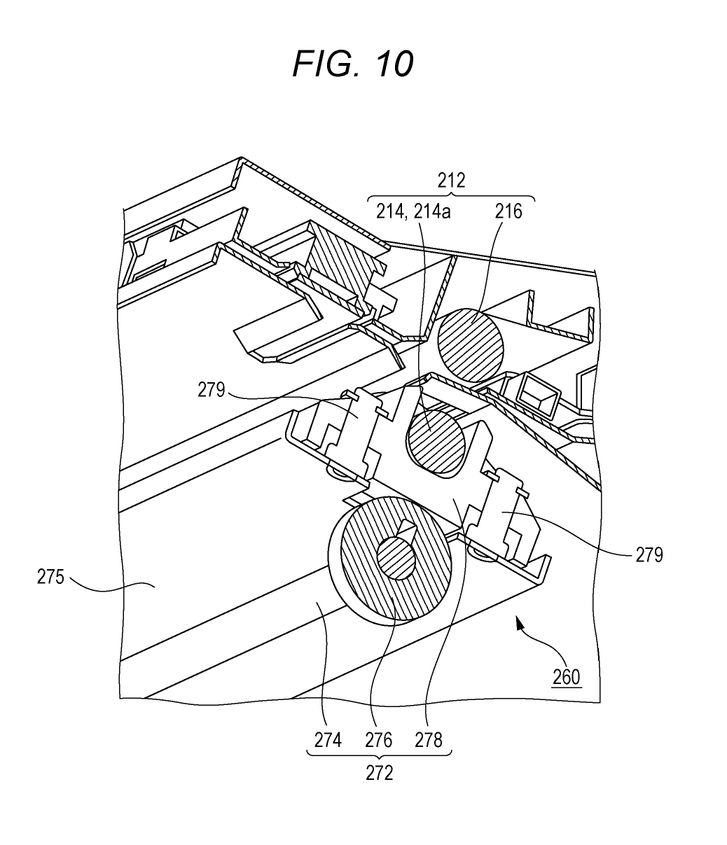

Next, a variation of the backup member 262 will be described. FIG. 8 illustrates an example of the configuration of a backup member 272. FIG. 9 illustrates an example of the configuration of the registration unit 200A when viewed in the paper conveyance direction D1. FIG. 10 illustrates an example of the configuration of the backup member 272. The backup member 272 includes a shaft 274, a deflection preventive cam 276, and a bearing 278 as illustrated in FIGS. 8 to 10.

The bearing 278 is a sliding bearing with a substantially U-shaped bearing surface and is fitted upward into the shaft 214a of the registration roller 214 between the adjacent rubber rollers 214b and 214b to rotatably support the shaft 214a. The bearing surface of the bearing 278 is substantially U-shaped to be able to prevent a shift of the shaft 214a in the paper conveyance direction D1. A support plate 275 is provided on a bottom surface side of the bearing 278, and shaft members 279 and 279 are crimped onto the support plate 275. The bearing 278 is attached to the shaft members 279 and 279 to be able to move with the shaft member 279 as a guide in response to a push-up action of the deflection preventive cam 276. As a result, the bearing 278 abuts on or separates from the shaft 214a of the registration roller 214.

The shaft 274 extends parallel to the shaft 214a of the registration roller 214, where both ends of the shaft 274 are rotatably supported by bearings (not shown) provided in the panels 208 and 209. The shaft 274 is connected to a driving motor (not shown) via a gear or the like and rotates with driving of the driving motor. The shaft 274 is made of material such as SUS.

The deflection preventive cam 276 is a disk cam that is disposed between the adjacent rubber rollers 214b and 214b making up the registration roller 214 and can abut on or separate from a bottom surface of the bearing 278 according to an angle of rotation. The deflection preventive cam 276 and the bearing 278 forming a pair are disposed at two sites at a certain interval along a longitudinal direction of the shaft 274. Note that while two of each of the deflection preventive cam 276 and the bearing 278 are provided in the present example, one or three or more of each of the cam and the bearing may be provided as well.

[Example of Configuration of Image Forming Apparatus 100]

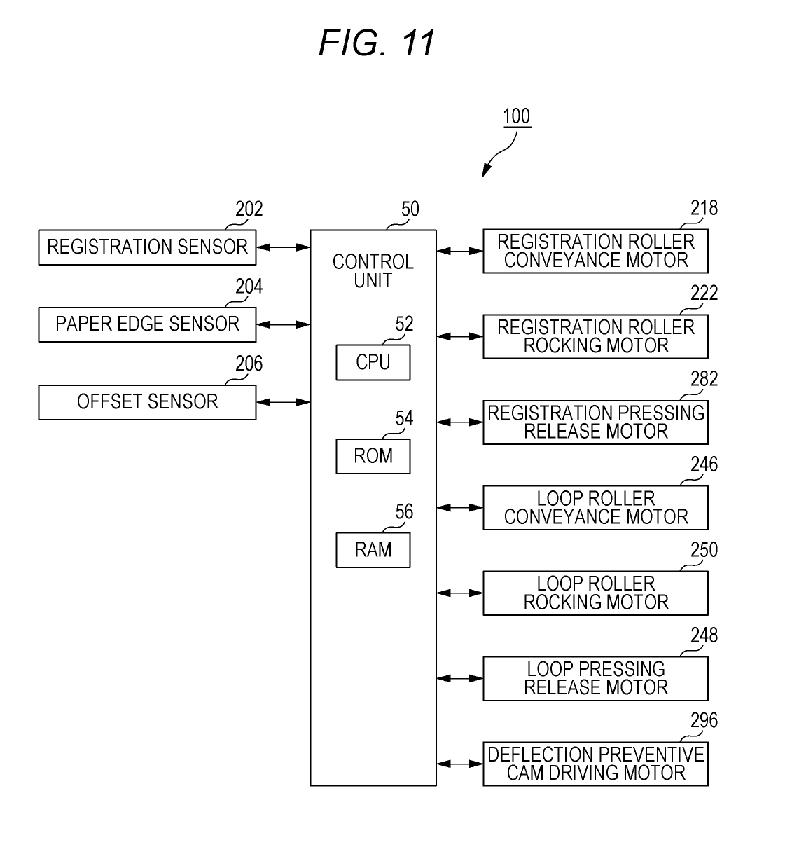

FIG. 11 is a block diagram illustrating an example of the functional configuration of the image forming apparatus 100. As illustrated in FIG. 11, the image forming apparatus 100 includes a control unit 50 that controls the operation of the entire apparatus. The control unit 50 includes a CPU (Central Processing Unit) 52, a ROM (Read Only Memory) 54, and a RAM (Random Access Memory) 56. The CPU 52 executes software (a program) read from the ROM 54 to control each unit in the image forming apparatus 100 and implement a function related to image formation including nip load control on the registration roller pair 212.

Connected to the control unit 50 are the registration sensor 202, a paper edge sensor 204, the offset sensor 206, a registration roller conveyance motor 218, the registration roller rocking motor 222, the registration pressing release motor 282, a loop roller conveyance motor 246, a loop roller rocking motor 250, a loop pressing release motor 248, and a deflection preventive cam driving motor 296.

The paper edge sensor 204 is formed of a light-reflecting or transmitting sensor, for example, and senses a leading edge of the paper P passing through the registration roller pair 212 to supply a detection signal to the control unit 50.

The registration roller conveyance motor 218 is driven on the basis of a drive signal supplied from the control unit 50 and rotationally drives the registration roller pair 212 to convey the paper P along the paper conveyance direction D1. The registration roller rocking motor 222 is driven on the basis of a drive signal supplied from the control unit 50 to move the registration roller pair 212 along the axial direction D2. The registration pressing release motor 282 is driven on the basis of a drive signal supplied from the control unit 50 to cause the registration roller pair 212 to abut on and separate from each other.

The loop roller conveyance motor 246 is driven on the basis of a drive signal supplied from the control unit 50 and rotationally drives the loop roller pair 240 to convey the paper P along the paper conveyance direction D1. The loop roller rocking motor 250 is driven on the basis of a drive signal supplied from the control unit 50 to move the loop roller pair 240 along the axial direction D2. The loop pressing release motor 248 is driven on the basis of a drive signal supplied from the control unit 50 to cause the loop roller pair 240 to abut on and separate from each other.

The deflection preventive cam driving motor 296 is driven on the basis of a drive signal supplied from the control unit 50 and rotates the shafts 264 and 274 to move the deflection preventive cams 266 and 276 to a deflection prevention position and a deflection preventive cam separation position.

[Example of Operation of Image Forming Apparatus 100]

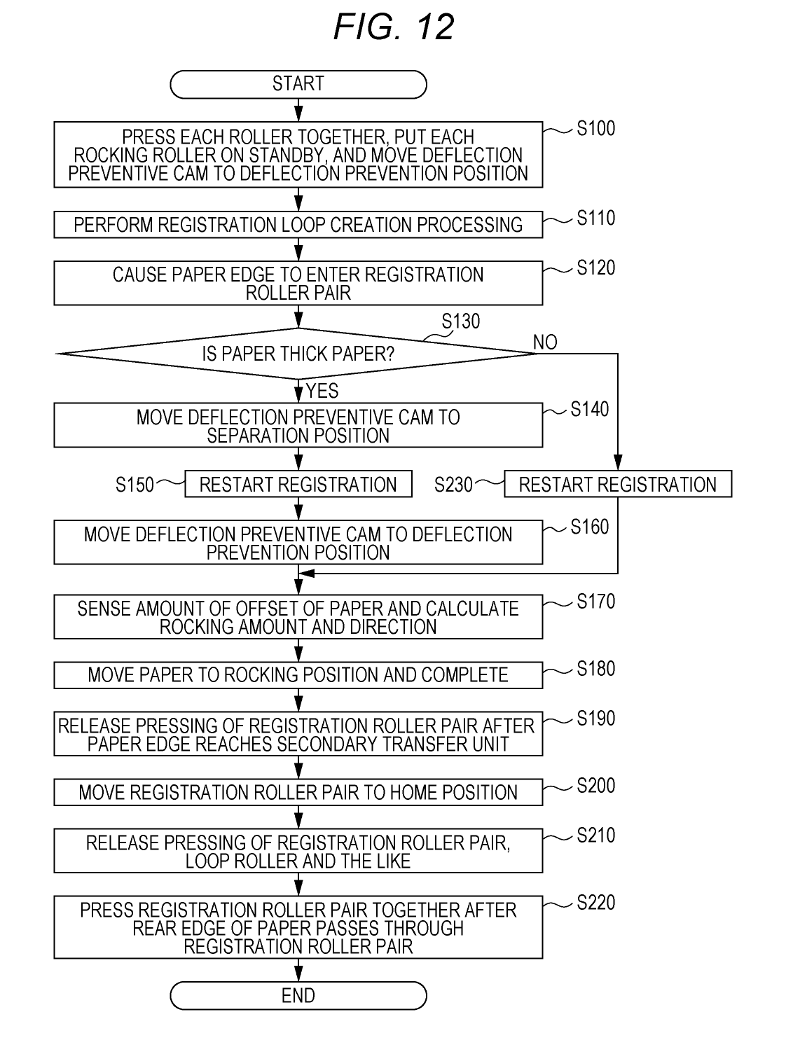

FIG. 12 is a flowchart illustrating an example of the operation of the image forming apparatus 100 when performing image formation processing. The control unit 50 of the image forming apparatus 100 runs a program read from a memory such as the ROM 54 to execute an operation sequence illustrated in the flowchart in FIG. 12. Note that there will be described a case where the backup member 272 is used as the nip load adjustment mechanism 260.

When a job is started, the control unit 50 in step S100 controls each of the registration roller pair 212, the loop roller pair 240, and the conveyance roller upstream of these rollers in the paper conveyance direction D1 to be pressed together. The control unit 50 further controls each of the rocking mechanism 220 rocking the registration roller pair 212 and a rocking mechanism rocking the loop roller pair 240 to be on standby.

Moreover, the control unit 50 moves the deflection preventive cam 276 to the deflection prevention position (position at which the distance from the center to the circumference is long). This causes the bearing 278 to be pushed up by the deflection preventive cam. 276 to also cause the shaft 214a of the registration roller 214 to be pushed up. As a result, a deflection in the shaft 214a of the registration roller 214 can be prevented to allow the registration roller pair 212 to be pressed together with a strong nip load. The nip load of the registration roller pair 212 in this case will be hereinafter referred to as a first nip load. The operation proceeds to step S110 after completing the processing in step S100.

In step S110, the control unit 50 starts loop creation processing for the paper P. The control unit 50 creates a loop of the paper P by driving the loop roller pair 240 to perform forward rotation and driving or stopping the registration roller pair 212 to perform backward rotation, for example. The operation proceeds to step S120 after completing the processing in step S110.

In step S120, the leading edge of the paper P enters between the nipped registration roller pair 212 by the registration loop creation processing.

In step S130, the control unit 50 acquires paper information of the paper P and determines whether or not the paper P is thick paper. The paper information can be acquired from an information terminal such as a personal computer connected via a network or acquired on the basis of an input performed by a user on the operation display unit 70. The control unit 50 proceeds to step S140 upon determining that the paper P is the thick paper. Note that the determination in step S130 can also be made at the stage of acquiring job information (paper information). The determination may for example be made before step S100 or between step S100 and step S120.

In step S140, the control unit 50 moves the registration roller pair 212 to the deflection preventive cam separation position (position at which the distance from the center to the circumference is short) before restarting the registration roller pair 212. This causes the deflection preventive cam 276 to separate from the bearing 278, thereby causing the bearing 278 to be separated from the shaft 214a of the registration roller 214. As a result, the registration roller pair 212 has a deflection to an allowable degree and is thus pressed together with a weak nip load. The nip load of the registration roller pair 212 in this case will be hereinafter referred to as a second nip load.

In step S150, the control unit 50 resumes conveyance of the paper P by restarting the registration roller pair 212 and the loop roller pair 240. Here, the first nip load of the registration roller pair 212 at the time of paper edge alignment which corrects the paper skew by striking the leading edge of the paper against the registration roller pair 212 and the second nip load of the registration roller pair 212 at the time of reconveying the paper P with the registration roller pair 212 satisfy the following relational expression (1).

First nip load>second nip load>0 (1)

A large load is generated in the registration roller pair 212 of the related art since the thick paper is conveyed while forcedly opening the nip. On the other hand, in the present invention, the registration roller pair 212 has the second nip load to thus be able to reduce the torque of forcedly opening the nip and prevent the large load in the registration roller pair 212. The control unit 50 further causes rollers such as the loop roller pair 240 to be separated from each other by releasing the pressing of the rollers.

In step S160, the control unit 50 moves the deflection preventive cam 276 from the deflection preventive cam separation position to the deflection prevention position. This causes the deflection preventive cam 276 to abut on the bearing 278, which is thus pushed up to pressure the shaft 214a of the registration roller 214. As a result, the registration roller pair 212 is pressed together with a strong nip load. The nip load of the registration roller pair 212 in this case will be hereinafter referred to as a third nip load. The operation proceeds to step S170 after completing step S160.

On the other hand, the control unit 50 proceeds to step S230 upon determining that the paper P is not the thick paper in step S130. In step S230, the control unit 50 resumes conveyance of the paper P by restarting the registration roller pair 212 and the loop roller pair 240. The nip load of the registration roller pair 212 at this time is the first nip load. This is because the torque of forcedly opening the nip of the registration roller pair 212 at the time of reconveying the paper is reduced when the paper is not the thick paper. The control unit 50 further causes rollers such as the loop roller pair 240 to be separated from each other by releasing the pressing of the rollers. The operation proceeds to step S170 after completing step S230.

With the paper P being reconveyed, the control unit 50 in step S170 acquires a position of the edge of the paper P sensed by the offset sensor 206 and calculates an amount of offset of the paper P. On the basis of the position of the edge of the paper P acquired, the control unit 50 calculates a rocking amount (rocking command value) and a rocking direction (a positive or negative direction) of the paper P. The operation proceeds to step S180 after completing step S170.

In step S180, the control unit 50 causes the registration roller pair 212 to rock in the axial direction D2 with the paper P held by the registration roller pair 212 while conveying the paper P along the paper conveyance direction D1 on the basis of information on the calculated rocking amount and rocking direction of the paper P. At this time, the third nip load of the registration roller pair 212 while the registration roller pair 212 is moving in the axial direction D2 satisfies the following relational expression (2).

First nip load≧third nip load>second nip load>0 (2)

Note that while the third nip load equals the first nip load in the present example, the nip load of the registration roller pair 212 may be adjusted such that the third nip load is smaller than the first nip load.

The control unit 50 stops moving the registration roller pair 212 in the axial direction D2 once rocking of the paper P in the axial direction D2 is completed. The offset of the paper P is corrected as a result. The paper P is conveyed toward the secondary transfer unit 34. At this time, a fourth nip load of the registration roller pair 212 while the registration roller pair 212 is conveying the paper toward the secondary transfer unit 34 after moving in the axial direction D2 satisfies the following relational expressions (3) and (4).

First nip load≧fourth nip load>second nip load>0 (3)

Third nip load≧fourth nip load>0 (4)

Note that while the fourth nip load equals the first and third nip loads in the present example, the nip load of the registration roller pair 212 may be adjusted such that the fourth nip load is smaller than the first nip load and the like.

Once the leading edge of the paper P being conveyed reaches the secondary transfer unit 34, the control unit 50 in step S190 releases the pressing of the registration roller pair 212 in order to convey the paper P by the secondary transfer unit 34 alone. The operation proceeds to step S200 after completing step S190.

In step S200, the control unit 50 rocks (returns) the registration roller pair 212 to a home position. The operation proceeds to step S210 after completing step S200.

In step S210, the control unit 50 releases the pressing of the loop roller pair 240 and the conveyance roller upstream thereof while the registration roller pair 212 is moved to the home position. The operation proceeds to step S220 after completing step S210.

In step S220, the control unit 50 causes the registration roller pair 212 to be pressed together after the registration roller pair 212 moves back to the home position and a rear edge of the paper P passes through the registration roller pair 212. The nip load of the registration roller pair 212 at this time is the first nip load. This allows the apparatus to get ready for offset correction and the like to be performed on succeeding paper. In the present example, the aforementioned series of processing is repeated for each paper.

[Timing Chart of Image Forming Apparatus 100 at the Time of Image Formation]

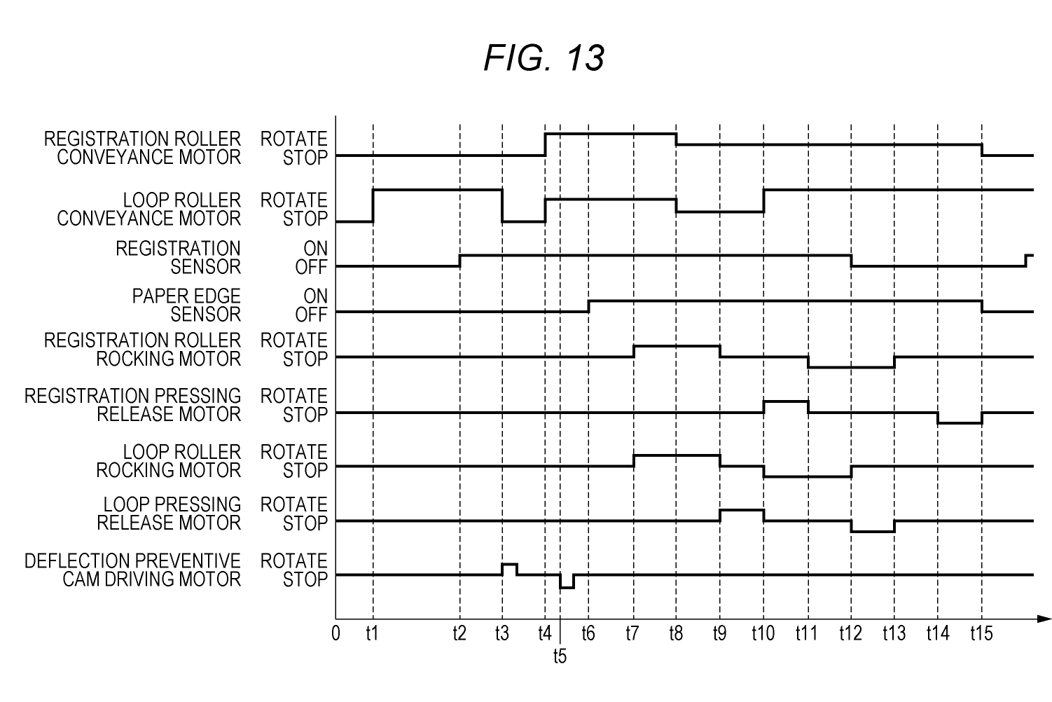

FIG. 13 illustrates an example of a timing chart of the image forming apparatus 100 at the time of image formation. As illustrated in FIG. 13, at time t1, the control unit 50 turns on the loop roller conveyance motor 246 to rotate the loop roller pair 240 and convey the paper P toward the registration roller pair 212.

With the paper P being conveyed by the loop roller pair 240, the registration sensor 202 senses the leading edge of the paper P at time t2. The control unit 50 calculates a timing to stop the loop roller pair 240 on the basis of a result of sensing by the registration sensor 202.

As the paper P is conveyed by the loop roller pair 240, the leading edge of the paper P is struck against the registration roller pair 212 and bent to form a predetermined amount of loop in the paper P (the registration loop creation processing). The skew of the paper P is corrected by the registration loop creation processing.

At time t3, the control unit 50 turns off the loop roller conveyance motor 246 to stop the rotation of the loop roller pair 240. The control unit 50 also turns on the deflection preventive cam driving motor 296 (to perform forward rotation) and rotates the deflection preventive cam 276 to the deflection prevention position so that the nip load of the registration roller pair 212 equals the first nip load.

At time t4, the control unit 50 starts reconveyance of the paper P by turning on the registration roller conveyance motor 218 and the loop roller conveyance motor 246 to rotate the registration roller pair 212 and the loop roller pair 240, respectively (registration reconveyance processing).

At time t5, the control unit 50 turns on the deflection preventive cam driving motor 296 (to perform reverse rotation) and rotates the deflection preventive cam 276 to the deflection preventive cam separation position, so that the shaft 214a of the registration roller pair 212 and the like has a deflection that is allowable and thus the nip load of the registration roller pair 212 equals the second nip load.

Once the paper P starts to be reconveyed, the paper edge sensor 204 senses the leading edge of the paper P at time t6. The control unit 50 calculates an amount of misregistration between the leading edge of the paper P and the edge of the image transferred to the intermediate transfer belt 8 on the basis of a result of sensing by the paper edge sensor 204.

Moreover, once the paper P starts to be reconveyed, the offset sensor 206 senses the edge of the paper P in the axial direction D2. That is, the sensor senses the amount of offset of the paper P in the axial direction D2. The control unit 50 calculates the rocking command value based on the amount of offset sensed by the offset sensor 206.

At time t7, the control unit 50 turns on the registration roller rocking motor 222 on the basis of the rocking command value to rock the registration roller pair 212 in the axial direction D2. At the same time, the control unit 50 turns on the loop roller rocking motor 250 on the basis of the rocking command value to rock the loop roller pair 240 in the axial direction D2. As a result, the paper P being held between each of the registration roller pair 212 and the loop roller pair 240 rocks in the axial direction D2, whereby the offset of the paper P is corrected.

At time t8, the control unit 50 decelerates the registration roller conveyance motor 218 and the loop roller conveyance motor 246 on the basis of the calculated amount of misregistration between the edge of the image and the leading edge of the paper P, and thus decelerates the rotation of the registration roller pair 212 and the loop roller pair 240. As a result, the registration between the leading edge of the paper P and the edge of the image transferred to the intermediate transfer belt 8 is corrected (edge correction).

At time t9, the control unit turns off the registration roller rocking motor 222 and the loop roller rocking motor 250 to stop the registration roller pair 212 and the loop roller pair 240, after completing the rocking based on the rocking command value. The control unit 50 also turns on the loop pressing release motor 248 to separate the loop roller pair 240 by releasing the nip thereof before releasing the registration roller pair 212.

At time t10, the control unit 50 turns on the registration pressing release motor 282 to separate the registration roller pair 212 by releasing the pressing thereof.

Moreover, at time t10, the control unit 50 drives the loop roller rocking motor 250 in reverse (to perform reverse rotation) and moves the loop roller pair 240 to the home position while being separated. The loop roller pair 240 is moved before the registration roller pair 212 because the rear edge of the paper passes through the loop roller pair 240 first as well as the succeeding paper reaches it first. In order to take in the succeeding paper, the control unit 50 also accelerates the loop roller conveyance motor 246 back to a paper feeding linear speed.

At time t11, the control unit 50 drives the registration roller rocking motor 222 in reverse (to perform reverse rotation) and moves the registration roller pair 212 to the home position while being separated.

At time t12, the control unit 50 turns off the loop roller rocking motor 250 to stop the rocking action of the loop roller pair 240. With the rocking action being stopped, the control unit 50 also turns on (drives in reverse) the loop pressing release motor 248 to cause the loop roller pair 240 to be pressed together.

At time t13, the control unit 50 turns off the registration roller rocking motor 222 to stop the rocking action of the registration roller pair 212 to its home position.

At time t14, the control unit 50 turns on the registration pressing release motor 282 on the basis of the result of sensing by the registration sensor 202 and causes the registration roller pair 212 to be pressed together.

According to the first embodiment described above, the deflection of the shaft 214a of the registration roller 214 is canceled by the backup members 262 and 272 at the time of aligning the paper edge, rocking the registration roller pair 212 in the axial direction D2 and conveying the paper P to the secondary transfer unit 34, in which cases the loads on the registration roller conveyance motor 218 and the registration roller rocking motor 222 are not too large. The nip load of the registration roller pair 212 can thus be increased to be able to ensure the skew correcting capability at the time of aligning the paper edge, prevent an increase in a thrust load caused by the deflection of the shaft 214a at the time of rocking, and ensure the force that holds the paper P at the time of conveyance.

Moreover, in the case where the load on the registration roller conveyance motor 218 is increased because the nip of the registration roller pair 212 is forcedly opened in reconveying the paper P after aligning the paper edge, the backup members 262 and 272 are displaced to allow the shaft 214a of the registration roller 214 to deflect freely by a predetermined amount in a vertical direction. The nip load of the registration roller pair 212 can thus be decreased to be able to prevent an increase in the load torque of the registration roller conveyance motor 218 and the like in forcedly opening the nip.

Furthermore, according to the first embodiment, the nip load can be selected according to paper (medium) being used to be able to achieve high productivity and support thick paper without causing a trouble.

### Second Embodiment

In a second embodiment, a nip load of a registration roller pair 212 is adjusted by using a pressing/separation mechanism 380 instead of using a backup member 262 and the like as described in the first embodiment. Note that the other configuration and operation of an image forming apparatus 100 including a registration unit 200B are similar to those of the first embodiment, whereby a detailed description of a common component will be omitted.

[Example of Configuration of Pressing/Separation Mechanism 380]

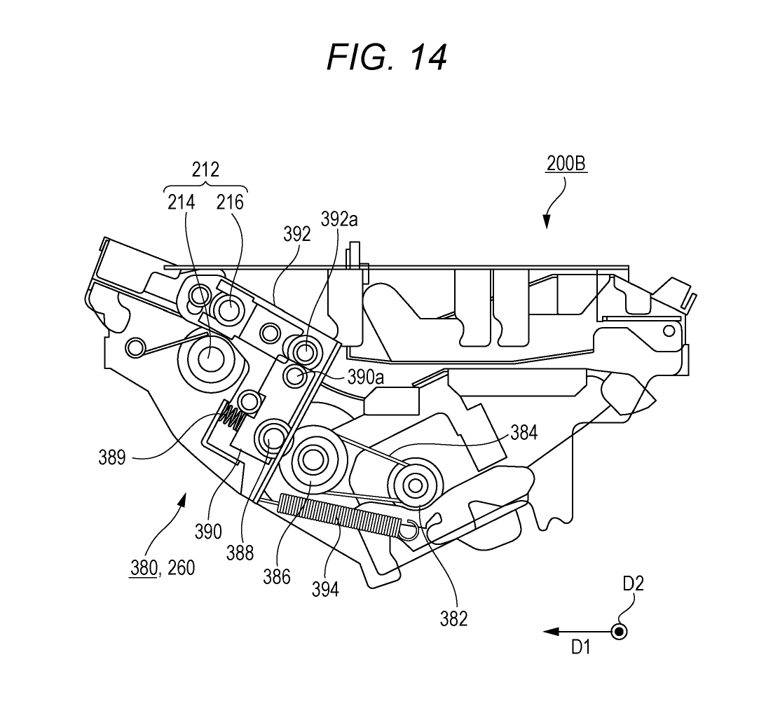

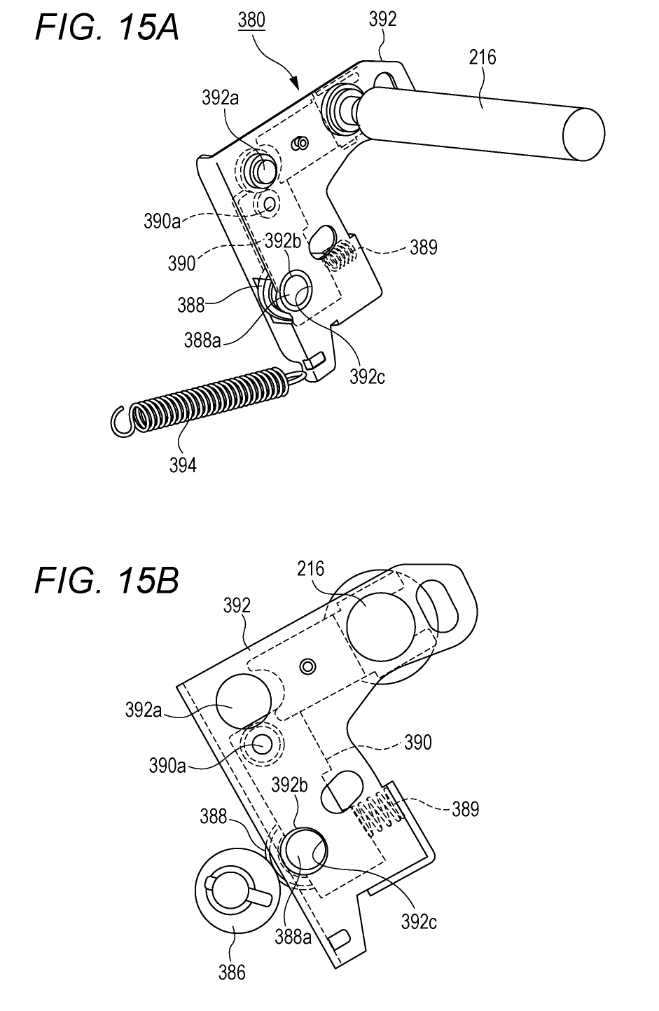

FIG. 14 illustrates an example of the configuration of the registration unit 200B according to the second embodiment. Each of FIGS. 15A and 15B illustrates an example of the configuration of the pressing/separation mechanism 380.

In the second embodiment, a nip load adjustment mechanism 260 adjusting the nip load of the registration roller pair 212 is formed of the pressing/separation mechanism 380. The pressing/separation mechanism 380 is obtained by partially modifying the configuration of the pressing/separation mechanism 280 described in the first embodiment. Accordingly, a configuration common to that of the pressing/separation mechanism 280 will be assigned a reference numeral different from that assigned thereto but will not be described in detail, whereby a detailed description of only a different configuration will be given.

As illustrated in FIG. 14, the pressing/separation mechanism 380 includes a driven roller holding member 392, a registration pressing release motor 382, a pressing/separation cam 386, a pressing/separation cam follower 388, a registration roller pressure spring 394, a cam follower holding member 390, and a cam follower pressure spring 389. The registration roller pressure spring 394 is an example of a first energizing member in the present disclosure.

The cam follower holding member 390 is a member holding the pressing/separation cam follower 388 and is attached to the driven roller holding member 392. A rotary shaft 390a is provided at one end of the cam follower holding member 390, while the pressing/separation cam follower 388 is attached to another end of the cam follower holding member 390. As a result, the cam follower holding member 390 is adapted to turn (tilt) relatively to the driven roller holding member 392 about the rotary shaft 390a as a pivot in response to a push-up action of the pressing/separation cam follower 388 caused by the pressing/separation cam 386.

One end of the cam follower pressure spring 389 is attached to an end face of the cam follower holding member 390 at the other end, while another end of the spring is attached to the driven roller holding member 392. The cam follower pressure spring 389 is formed of a compression spring, for example, and energizes the pressing/separation cam follower 388 toward the pressing/separation cam 386 through the cam follower holding member 390. The cam follower pressure spring 389 is an example of a second energizing member in the present disclosure.

As illustrated in FIGS. 15A and 15B, the driven roller holding member 392 includes an opening 392b at a position corresponding to the pressing/separation cam follower 388. The opening 392b is a longhole, for example, through which a projection 388a provided to the pressing/separation cam follower 388 is inserted. A movement of the pressing/separation cam follower 388 is regulated at the opening 392b in a manner that the projection 388a of the pressing/separation cam follower 388 abuts on a rim of the opening 392b upon moving relatively to the driven roller holding member 392 with the push-up action of the pressing/separation cam follower 388. In the present example, the rim of the opening 392b on which the projection 388a of the pressing/separation cam follower 388 abuts is called a stopper 389c.

[Example of Operation of Pressing/Separation Mechanism 380]

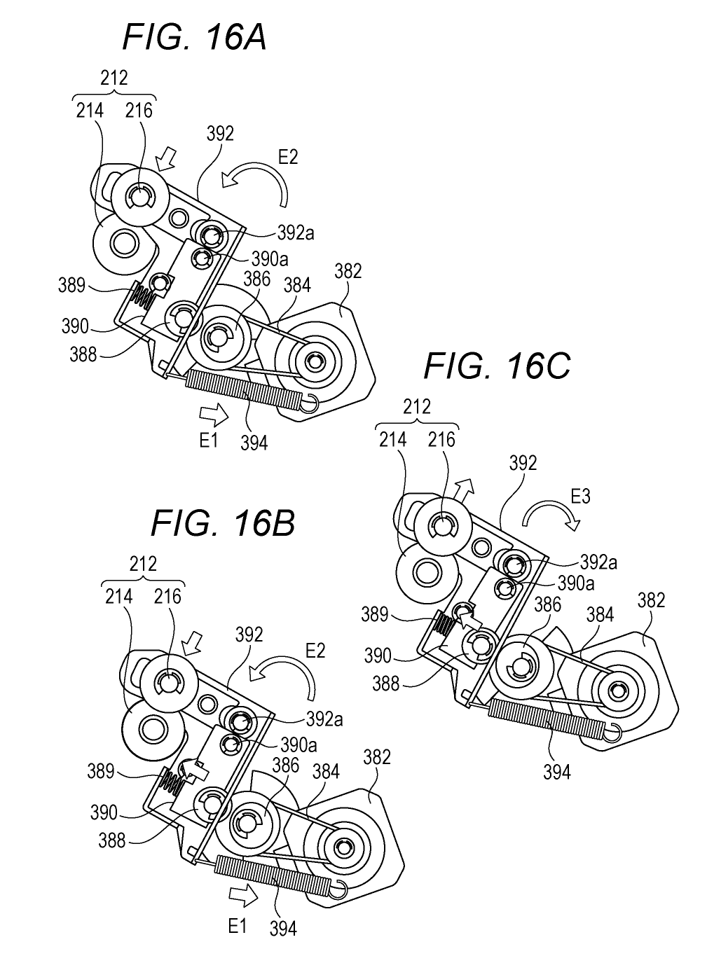

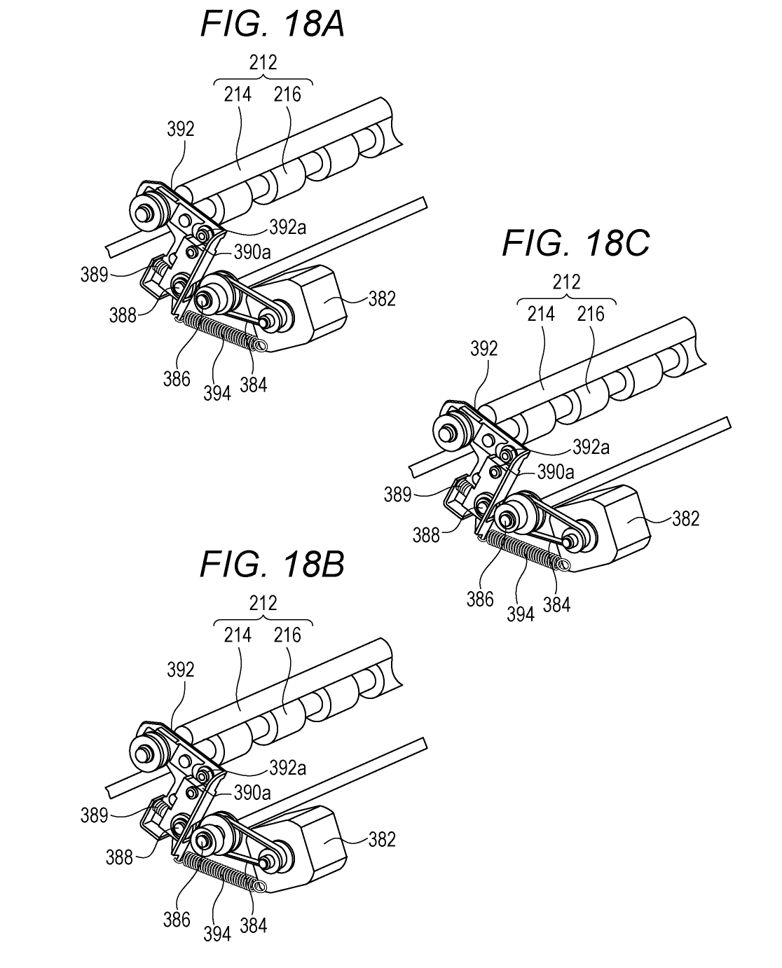

Each of FIGS. 16A, 17A and 18A illustrates an example of the operation of the pressing/separation mechanism 380 when strongly pressing the registration roller pair 212 together. In the present example, the pressing/separation cam 386 is at a strong nip load position at which the nip load of the registration roller pair 212 is strong when the distance from a center to a circumference of the cam 386 is the shortest.

As illustrated in FIGS. 16A, 17A and 18A, the pressing/separation cam 386 and the pressing/separation cam follower 388 are separated from each other when the pressing/separation cam 386 rotates to the strong nip load position by driving of the registration pressing release motor 382. This allows the driven roller holding member 392 to be energized (pulled) toward the registration pressing release motor 382 by the registration roller pressure spring 394 alone. As a result, the driven roller holding member 392 turns about a rotary shaft 392a as a pivot in an arrow direction E1 to cause a driven roller 216 to be pressed against a registration roller 214 with a strong nip load.

Each of FIGS. 16B, 17B and 18B illustrates an example of the operation of the pressing/separation mechanism 380 when weakly pressing the registration roller pair 212 together. In the present example, the pressing/separation cam 386 is at a weak nip load position at which the nip load of the registration roller pair 212 is weak when the distance from the center to the circumference of the cam 386 is the second longest.

As illustrated in FIGS. 16B, 17B and 18B, the pressing/separation cam 386 abuts on the pressing/separation cam follower 388 when the pressing/separation cam 386 rotates to the weak nip load position by driving of the registration pressing release motor 382. This causes the pressing/separation cam follower 388 to be pushed up, which causes the cam follower holding member 390 to tilt (rotate) about the rotary shaft 390a as a pivot so that the cam follower pressure spring 389 undergoes a displacement. The displacement of the cam follower pressure spring 389 causes a spring load (energizing force) in a direction opposite to that of the registration roller pressure spring 394. Here, the spring load of the registration roller pressure spring 394 is greater than (>) the spring load of the cam follower pressure spring 389, whereby the nip load of the driven roller 216 against the registration roller 214 is weaker than the nip load in the case where the cam is at the strong nip load position. As a result, the driven roller 216 is pressed against the registration roller 214 with a weak nip load.

Each of FIGS. 16C, 17C and 18C illustrates an example of the operation of the pressing/separation mechanism 380 when releasing the pressing of the registration roller pair 212. In the present example, the pressing/separation cam 386 is at a nip release position at which the registration roller pair 212 is separated from each other when the distance from the center to the circumference of the cam 386 is the third longest.

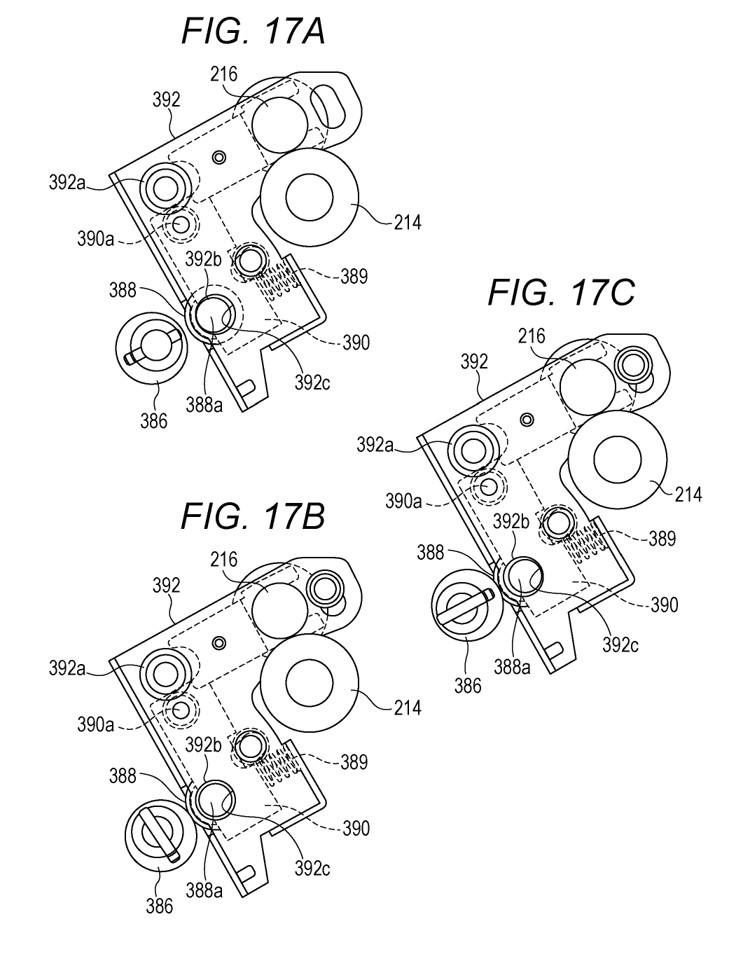

As illustrated in FIGS. 16C, 17C and 18C, when the pressing/separation cam 386 rotates to the nip release position by driving of the registration pressing release motor 382, the pressing/separation cam follower 388 is pushed up further than the case where the cam is at the weak nip load position. The pressing force of the pressing/separation cam 386 is larger than the energizing force of the registration roller pressure spring 394. This allows the projection 388a of the pressing/separation cam follower 388 to move into the opening 392b of the driven roller holding member 392 and abut on the stopper 392c (refer to FIG. 17C). Once the projection 388a abuts on the stopper 392c, the driven roller holding member 392 turns about the rotary shaft 392a as the pivot in an arrow direction E3. As a result, the driven roller 216 moves in a direction away from the registration roller 214 to be separated from the registration roller 214.

[Example of Operation of Image Forming Apparatus 100]

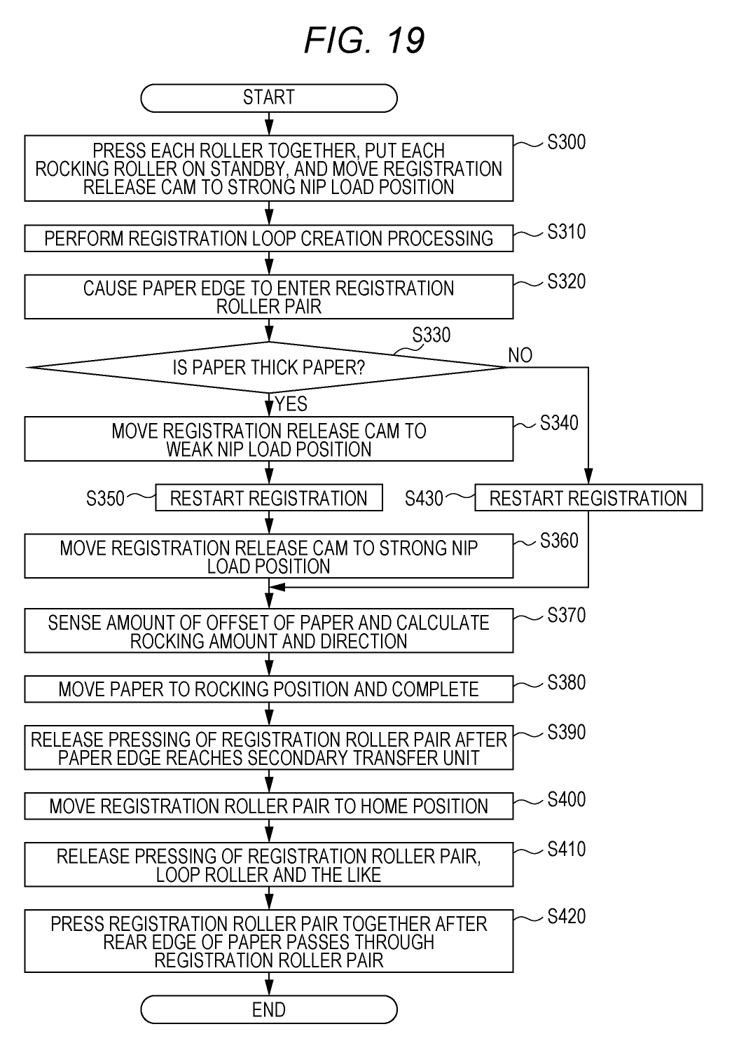

FIG. 19 is a flowchart illustrating an example of the operation of the image forming apparatus 100 at the time of image formation. The control unit 50 of the image forming apparatus 100 runs a program read from a memory such as a ROM 54 to execute an operation sequence illustrated in the flowchart in FIG. 19. Note that what is common to the processing described with reference to FIG. 12 in the first embodiment will not be described in detail.

With a job being started, a control unit 50 in step S300 causes the registration roller pair 212 and the like to be pressed together. The control unit 50 also moves the pressing/separation cam 386 to the strong nip load position. As a result, the registration roller pair 212 is pressed together with a strong nip load. The nip load of the registration roller pair 212 in this case will be hereinafter referred to as a fifth nip load. The operation proceeds to step S310 after completing step S300.

In step S310, the control unit 50 starts loop creation processing for the paper P. The operation proceeds to step S320 after completing step S310.

In step S320, a leading edge of the paper P enters between the nipped registration roller pair 212 by the registration loop creation processing.

In step S330, the control unit 50 acquires paper information of the paper P and determines whether or not the paper P is thick paper. The control unit 50 proceeds to step S340 upon determining that the paper P is the thick paper. The determination in step S330 may be made before step S300 or between step S300 and step S320.

In step S340, the control unit 50 moves the pressing/separation cam 386 to the weak nip load position before restarting the registration roller pair 212. As a result, the registration roller pair 212 is pressed together with a weak nip load. The nip load of the registration roller pair 212 in this case will be hereinafter referred to as a sixth nip load.

In step S350, the control unit 50 resumes conveyance of the paper P by restarting the registration roller pair 212 and the like. In the present example, the fifth nip load of the registration roller pair 212 at the time of paper edge alignment which corrects a paper skew by striking the leading edge of the paper against the registration roller pair 212 and the sixth nip load of the registration roller pair 212 at the time of reconveying the paper P with the registration roller pair 212 satisfy the following relational expression (5).

Fifth nip load>sixth nip load>0 (5)

According to the present example, the registration roller pair 212 is nipped with the sixth nip load at the time of reconveying the paper, so that the torque of forcedly opening the nip of the registration roller pair 212 can be decreased even when the thick paper is used. The control unit 50 further causes rollers such as the loop roller pair 240 to be separated from each other by releasing the pressing of the rollers. The operation proceeds to step S360 after completing step S350.

In step S360, the control unit 50 moves the pressing/separation cam 386 from the weak nip load position to the strong nip load position. As a result, the registration roller pair 212 is pressed together with a strong nip load once again. The nip load of the registration roller pair 212 in this case will be hereinafter referred to as a seventh nip load. The operation proceeds to step S370 after completing step S360.

On the other hand, the control unit 50 proceeds to step S430 upon determining that the paper P is not the thick paper in step S330. In step S430, the control unit 50 resumes conveyance of the paper P by restarting the registration roller pair 212 and the like. The nip load of the registration roller pair 212 at this time is the fifth nip load. This is because the torque of forcedly opening the nip of the registration roller pair 212 is decreased since the paper P being used is not the thick paper. The control unit 50 further causes rollers such as the loop roller pair 240 to be separated from each other by releasing the pressing of the rollers. The operation proceeds to step S370 after completing step S430.

In step S370, the control unit 50 acquires a position of the edge of the paper P sensed by the offset sensor 206 and calculates an amount of offset of the paper P. On the basis of the position of the edge of the paper P acquired, the control unit 50 calculates a rocking amount and a rocking direction of the paper P. The operation proceeds to step S380 after completing step S370.

In step S380, the control unit 50 causes the registration roller pair 212 to rock in an axial direction D2 with the paper P held by the registration roller pair 212 while conveying the paper P along the paper conveyance direction D1 on the basis of information on the calculated rocking amount and rocking direction of the paper P. At this time, the seventh nip load of the registration roller pair 212 while the registration roller pair 212 is moving in the axial direction D2 satisfies the following relational expression (6).

Fifth nip load≧seventh nip load>sixth nip load>0 (6)

Note that while the seventh nip load equals the fifth nip load in the present example, the nip load of the registration roller pair 212 may be adjusted such that the seventh nip load is smaller than the fifth nip load.

The control unit 50 stops moving the registration roller pair 212 in the axial direction D2 once rocking of the paper P in the axial direction D2 is completed. The offset of the paper P is corrected as a result. The paper P is conveyed toward a secondary transfer unit 34. At this time, an eighth nip load of the registration roller pair 212 while the roller pair is conveying the paper toward the secondary transfer unit 34 satisfies the following relational expressions (7) and (8).

Fifth nip load≧eighth nip load>sixth nip load>0 (7)

Seventh nip load≧eighth nip load>0 (8)

Note that while the eighth nip load equals the fifth and seventh nip loads in the present example, the nip load of the registration roller pair 212 may be adjusted such that the eighth nip load is smaller than the fifth nip load and the like.

Once the leading edge of the paper P being conveyed reaches the secondary transfer unit 34, the control unit 50 in step S390 releases the pressing of the registration roller pair 212 in order to convey the paper P by the secondary transfer unit 34 alone. The operation proceeds to step S400 after completing step S390.

In step S400, the control unit 50 rocks (returns) the registration roller pair 212 to a home position. The operation proceeds to step S410 after completing step S400.

In step S410, the control unit 50 releases the pressing of the loop roller pair 240 and the like while the registration roller pair 212 is moved to the home position. The operation proceeds to step S420 after completing step S410.

In step S420, the control unit 50 causes the registration roller pair 212 to be pressed together after the registration roller pair 212 moves back to the home position and a rear edge of the paper P passes through the registration roller pair 212. This allows the apparatus to get ready for offset correction and the like to be performed on succeeding paper. In the present example, the aforementioned series of processing is repeated for each paper.

[Timing Chart of Image Forming Apparatus 100 at the Time of Image Formation]

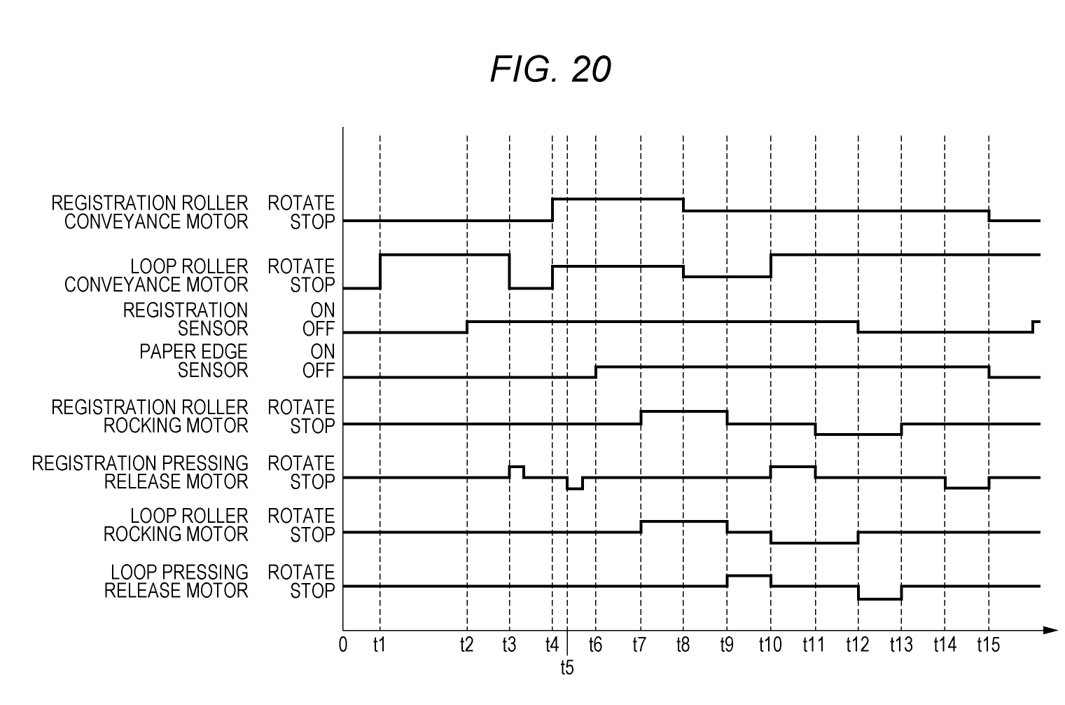

FIG. 20 illustrates an example of a timing chart of the image forming apparatus 100 at the time of image formation. Note that what is common to the processing described with reference to FIG. 13 in the first embodiment will not be described in detail.

As illustrated in FIG. 20, at time t1, the control unit 50 turns on a loop roller conveyance motor 246 to rotate the loop roller pair 240 and convey the paper P toward the registration roller pair 212.

With the paper P being conveyed by the loop roller pair 240, the registration sensor 202 senses the leading edge of the paper P at time t2. The control unit 50 calculates a timing to stop the loop roller pair 240 on the basis of a result of sensing by the registration sensor 202.

As the paper P is conveyed by the loop roller pair 240, the leading edge of the paper P is struck against the registration roller pair 212 and bent to form a predetermined amount of loop in the paper P (the registration loop creation processing). The skew of the paper P is corrected by the registration loop creation processing.

At time t3, the control unit 50 turns off the loop roller conveyance motor 246 to stop the rotation of the loop roller pair 240. The control unit 50 further turns on a registration pressing release motor 382 (to perform forward rotation) to rotate the pressing/separation cam 386 to the weak nip load position and cause the registration roller pair 212 to be pressed together with a weak nip load (such as the sixth nip load).

At time t4, the control unit 50 starts reconveyance of the paper P by turning on a registration roller conveyance motor 218 and the loop roller conveyance motor 246 to rotate the registration roller pair 212 and the loop roller pair 240, respectively (registration reconveyance processing).

At time t5, the control unit 50 turns on the registration pressing release motor 382 (to perform reverse rotation) to rotate the pressing/separation cam 386 to the strong nip load position and cause the registration roller pair 212 to be pressed together with a strong nip load (such as the fifth nip load).

Once the paper P starts to be reconveyed, the paper edge sensor 204 senses the leading edge of the paper P at time t6. The control unit 50 calculates an amount of misregistration between the leading edge of the paper P and the edge of the image transferred to an intermediate transfer belt 8 on the basis of a result of sensing by the paper edge sensor 204.

Moreover, once the paper P starts to be reconveyed, the offset sensor 206 senses the edge of the paper P in the axial direction D2. That is, the sensor senses the amount of offset of the paper P in the axial direction D2. The control unit 50 calculates the rocking command value based on the amount of offset sensed by the offset sensor 206.

At time t7, the control unit 50 turns on a registration roller rocking motor 222 on the basis of the rocking command value to rock the registration roller pair 212 in the axial direction D2. At the same time, the control unit 50 turns on a loop roller rocking motor 250 on the basis of the rocking command value to rock the loop roller pair 240 in the axial direction D2. As a result, the paper P being held between each of the registration roller pair 212 and the loop roller pair 240 rocks in the axial direction D2, whereby the offset of the paper P is corrected.

At time t8, the control unit 50 decelerates the registration roller conveyance motor 218 and the loop roller conveyance motor 246 on the basis of the calculated amount of misregistration between the edge of the image and the leading edge of the paper P, and thus decelerates the rotation of the registration roller pair 212 and the loop roller pair 240. As a result, the registration between the leading edge of the paper P and the edge of the image transferred to the intermediate transfer belt 8 is corrected (edge correction).

At time t9, the control unit turns off the registration roller rocking motor 222 and the loop roller rocking motor 250 to stop the registration roller pair 212 and the loop roller pair 240, after completing the rocking based on the rocking command value. The control unit 50 also turns on a loop pressing release motor 348 to separate the loop roller pair 240 by releasing the nip thereof before releasing the registration roller pair 212.

At time t10, the control unit 50 turns on the registration pressing release motor 382 to separate the registration roller pair 212 by releasing the pressing thereof.

Moreover, at time t10, the control unit 50 drives the loop roller rocking motor 250 in reverse (to perform reverse rotation) and moves the loop roller pair 240 to the home position while being separated. The loop roller pair 240 is moved before the registration roller pair 212 because the rear edge of the paper passes through the loop roller pair 240 first as well as the succeeding paper reaches it first. In order to take in the succeeding paper, the control unit 50 also accelerates the loop roller conveyance motor 246 back to a paper feeding linear speed.

At time t11, the control unit 50 drives the registration roller rocking motor 222 in reverse (to perform reverse rotation) and moves the registration roller pair 212 to the home position while being separated.

At time t12, the control unit 50 turns off the loop roller rocking motor 250 to stop the rocking action of the loop roller pair 240. With the rocking action being stopped, the control unit 50 also turns on (drives in reverse) the loop pressing release motor 248 to cause the loop roller pair 240 to be pressed together.

At time t13, the control unit 50 turns off the registration roller rocking motor 222 to stop the rocking action of the registration roller pair 212 to its home position.

At time t14, the control unit 50 turns on the registration pressing release motor 382 on the basis of the result of sensing by the registration sensor 202 and causes the registration roller pair 212 to be pressed together.

According to the second embodiment described above, the pressing/separation mechanism 380 allows the registration roller pair 212 to be pressed together with a relatively large nip load at the time of aligning the paper edge, rocking the registration roller pair 212 in the axial direction D2 and conveying the paper P to the secondary transfer unit 34, in which cases the loads on the registration roller conveyance motor 218 and the registration roller rocking motor 222 are not too large. As a result, the skew correcting capability at the time of aligning the paper edge can be ensured while at the same time preventing an increase in a thrust load caused by the deflection of the shaft 214a at the time of rocking and ensuring the force that holds the paper P at the time of conveyance.

Moreover, in the case where the load on the registration roller conveyance motor 218 is increased because the nip of the registration roller pair 212 is forcedly opened in reconveying the paper P after aligning the paper edge, the pressing/separation mechanism 380 allows the registration roller pair 212 to be pressed together with a relatively small nip load. As a result, an increase in the load torque of the registration roller conveyance motor 218 and the like in forcedly opening the nip can be prevented.

### Third Embodiment

In a third embodiment, a nip load of a registration roller pair 212 is adjusted by a configuration different from that of the pressing/separation mechanism 380 of the second embodiment. Note that the other configuration and operation of an image forming apparatus 100 including a registration unit 200C are similar to those of the first and second embodiments, whereby a detailed description of a common component will be omitted.

[Example of Configuration of Pressing/Separation Mechanism 480]

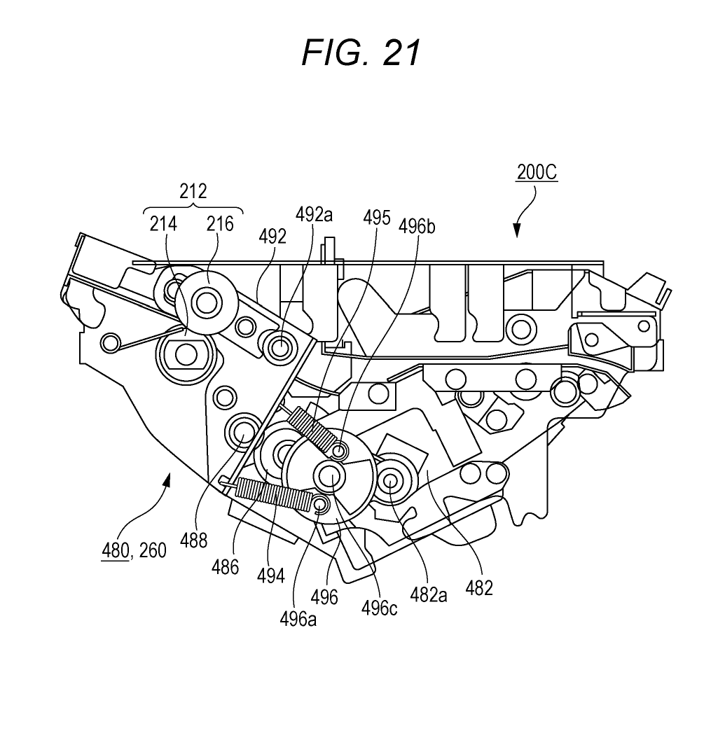

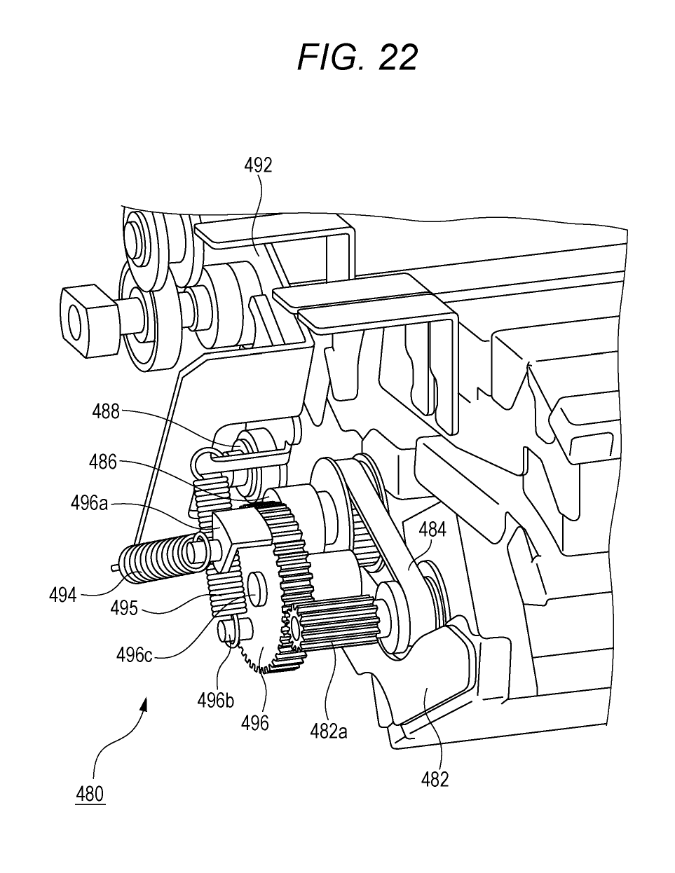

FIG. 21 illustrates an example of the configuration of the registration unit 200C according to the third embodiment. FIG. 21 illustrates a state of a pressing/separation mechanism 480 when releasing the nip of the registration roller pair 212. FIG. 22 illustrates an example of the configuration of the pressing/separation mechanism 480.

In the third embodiment, a nip load adjustment mechanism 260 adjusting the nip load of the registration roller pair 212 is formed of the pressing/separation mechanism 480. The pressing/separation mechanism 480 is obtained by partially modifying the configurations of the pressing/separation mechanisms 280 and 380 described in the first and second embodiments. Accordingly, a configuration common to that of the pressing/separation mechanisms 280 and 380 will be assigned a reference numeral different from that assigned thereto but will not be described in detail, whereby a detailed description of only a different configuration will be given.

As illustrated in FIGS. 21 and 22, the pressing/separation mechanism 480 includes a driven roller holding member 492, a registration pressing release motor 482, a pressing/separation cam 486, a pressing/separation cam follower 488, an energizing load support member 496, and registration nip load energizing members 494 and 495. Note that the registration pressing release motor 482 is an example of a drive unit of the present disclosure.

The energizing load support member 496 is a member adjusting the energizing force of the registration nip load energizing members 494 and 495 against the driven roller holding member 492. The energizing load support member 496 is a disk-shaped gear member that is connected to (in mesh with) a rotary shaft 482a of the registration pressing release motor 482 and rotates with rotational driving of the registration pressing release motor 482.

Provided on an outer surface of the energizing load support member 496 are an attachment portion 496a to which the registration nip load energizing member 494 is attached and an attachment portion 496b to which the registration nip load energizing member 495 is attached. The attachment portions 496a and 496b are disposed to be substantially symmetrical about a central shaft 496c of the energizing load support member 496. The attachment portion 496a projects from the outer surface (front side) of the energizing load support member 496 by a predetermined height such that the registration nip load energizing members 494 and 495 do not overlap each other.

Each of the registration nip load energizing members 494 and 495 is a member that adjusts the nip load of a driven roller 216 against a registration roller 214 by energizing the driven roller holding member 492 with an independent energizing force (load), and is formed of a tension spring, for example.

One end of the registration nip load energizing member 494 is attached to a lower corner of an end face of the driven roller holding member 492 facing the registration pressing release motor 482, while another end of the energizing member is attached to the attachment portion 496a of the energizing load support member 496. The registration nip load energizing member 494 is stretched or compressed depending on the angle of rotation of the energizing load support member 496 and imparts a predetermined energizing force (tensile force) to the driven roller holding member 492.

One end of the registration nip load energizing member 495 is attached to a substantially center part of the end face of the driven roller holding member 492 facing the registration pressing release motor 482, while another end of the energizing member is attached to the attachment portion 496b of the energizing load support member 496. The registration nip load energizing member 495 is stretched or compressed depending on the angle of rotation of the energizing load support member 496 and imparts a predetermined energizing force to the driven roller holding member 492.

[Example of Operation of Pressing/Separation Mechanism 480]

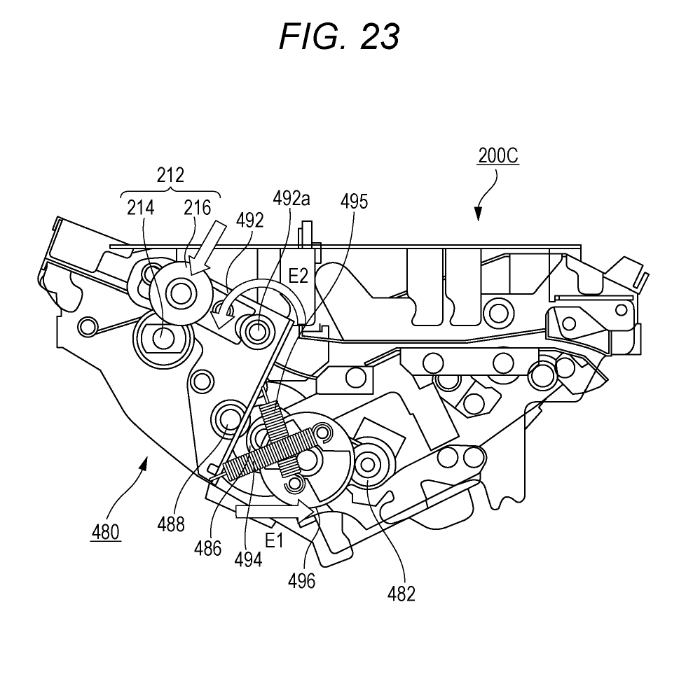

FIG. 23 illustrates an example of the operation of the pressing/separation mechanism 480 when increasing the nip load of the registration roller pair 212 pressed together. When the registration pressing release motor 482 is driven to rotate the energizing load support member 496 to a strong nip load position, as illustrated in FIG. 23, the registration nip load energizing members 494 and 495 intersect (are stretched) to cause the driven roller holding member 492 to be pulled toward the registration pressing release motor 482. That is, the driven roller holding member 492 is pulled in an arrow direction E1 by the two registration nip load energizing members 494 and 495. The pressing/separation cam 486 and the pressing/separation cam follower 488 are separated at this time, whereby the energizing force by pushing up of the pressing/separation cam 486 does not act on the driven roller holding member 492. As a result, the driven roller holding member 492 turns about a rotary shaft 492a as a pivot in an arrow direction E2 to cause the driven roller 216 to be pressed against the registration roller 214 with a strong nip load. In the present example, the nip load of the registration roller pair 212 in this case is referred to as a ninth nip load.

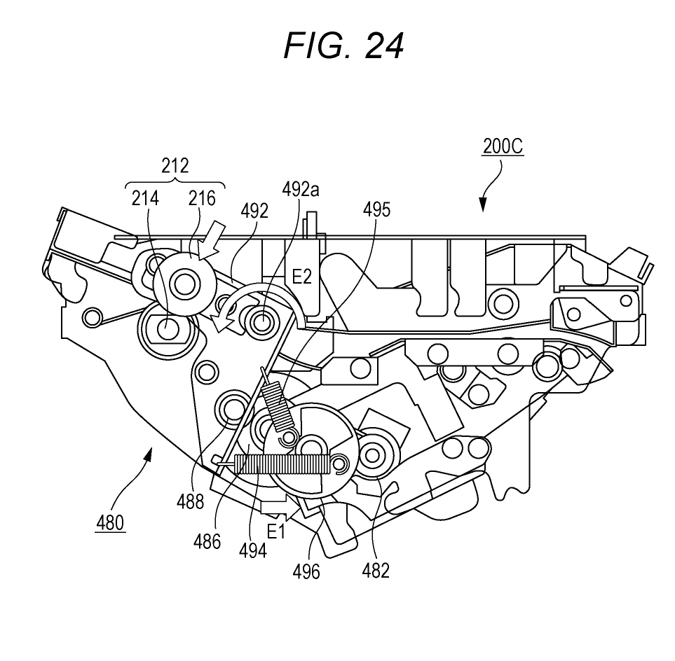

FIG. 24 illustrates an example of the operation of the pressing/separation mechanism 480 when decreasing the nip load of the registration roller pair 212 pressed together. When the registration pressing release motor 482 is driven to rotate the energizing load support member 496 to a weak nip load position, as illustrated in FIG. 24, the registration nip load energizing member 495 compresses to have no pressure in the spring, whereby the driven roller holding member 492 is pulled toward the registration pressing release motor 482 by the registration nip load energizing member 494 alone. That is, the driven roller holding member 492 is pulled in the arrow direction E1 by the registration nip load energizing members 494 alone. The pressing/separation cam 486 and the pressing/separation cam follower 488 are separated at this time, whereby the energizing force by pushing up of the pressing/separation cam 486 does not act on the driven roller holding member 492. As a result, compared to the case where the energizing load support member rotates to the strong nip load position, the energizing force exerted on the driven roller holding member 492 in the arrow direction E2 is slightly reduced so that the driven roller 216 is pressed against the registration roller 214 with a weak nip load. In the present example, the nip load of the registration roller pair 212 in this case is referred to as a tenth nip load.

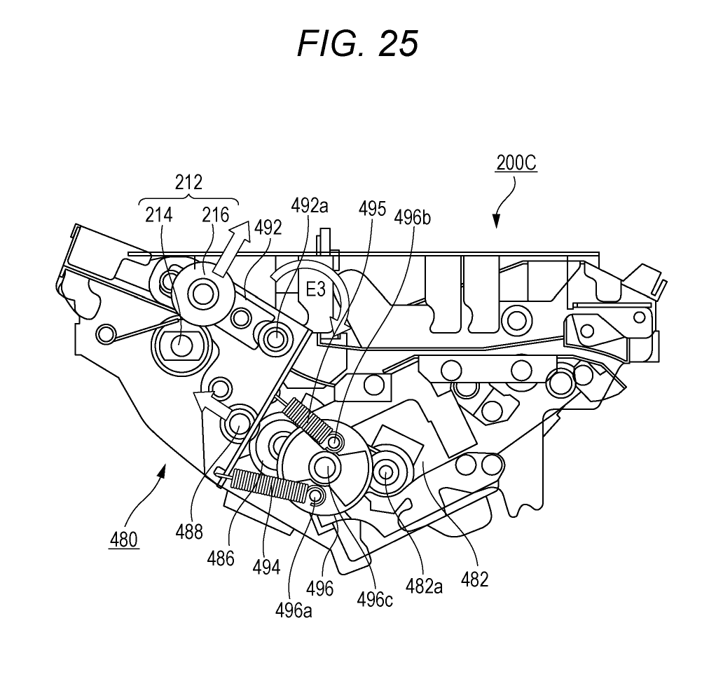

FIG. 25 illustrates an example of the operation of the pressing/separation mechanism 480 when releasing the pressing of the registration roller pair 212. When the pressing/separation cam 486 rotates to the nip release position by driving of the registration pressing release motor 482, as illustrated in FIG. 25, the pressing/separation cam 486 abuts on the pressing/separation cam follower 488, which is thus pushed up. The energizing load support member 496 also rotates to the nip release position with the pressing/separation cam 486 rotating to the nip release position. When the energizing load support member 496 rotates to the nip release position, a predetermined spring pressure by each of the registration nip load energizing members 494 and 495 is exerted on the driven roller holding member 492. However, the pushing force of the pressing/separation cam 486 is larger than the spring pressure (energizing force) of the registration nip load energizing members 494 and 495, so that the driven roller holding member 492 turns about the rotary shaft 492a as the pivot in an arrow direction E3. As a result, the pressing of the registration roller pair 212 is released to allow the driven roller 216 to be separated from the registration roller 214.

Note that while the spring pressure by each of the registration nip load energizing members 494 and 495 is exerted in the states illustrated in FIGS. 23 to 25 in the present example, the rotating force of the energizing load support member 496 is canceled to be substantially equal to 0 N. This means that the torque is smaller than or equal to a level at which moment to the registration pressing release motor 482 can be kept, whereby the nip load can be exerted stably at the stop position even when the registration pressing release motor 482 is turned off.

[Relationship Among Nip Loads of Registration Roller Pair 212 in Each Processing]

In the third embodiment, the registration roller pair 212 has the following nip load at the time of each processing performed in a job. The ninth nip load with which the registration roller pair 212 is nipped strongly can be adopted as the nip load of the registration roller pair 212 at the time of paper edge alignment in which a skew of the paper P is corrected by striking the leading edge of the paper against the registration roller pair 212. The tenth nip load with which the registration roller pair 212 is nipped weakly can be adopted as the nip load of the registration roller pair 212 at the time of reconveying the paper P by the registration roller pair 212. The ninth nip load can be adopted as the nip load of the registration roller pair 212 while the registration roller pair 212 moves in an axial direction D2 and while the registration roller pair 212 conveys the paper toward a secondary transfer unit 34 after moving in the axial direction D2.

Moreover, in the present example, the nip loads of the registration roller pair 212 in each processing satisfy the relationships (5) to (8) described in the second embodiment. A control unit 50 controls the operation of the pressing/separation mechanism 480 such that the aforementioned relationships (5) to (8) are satisfied.

According to the third embodiment described above, the pressing/separation mechanism 480 allows the registration roller pair 212 to be pressed together with a relatively large nip load at the time of aligning the paper edge, rocking the registration roller pair 212 in the axial direction D2 and conveying the paper P to the secondary transfer unit 34, in which cases the loads on a registration roller conveyance motor 218 and a registration roller rocking motor 222 are not too large. As a result, the skew correcting capability at the time of aligning the paper edge can be ensured while at the same time preventing an increase in a thrust load caused by the deflection of the shaft 214a at the time of rocking and ensuring the force that holds the paper P at the time of conveyance.

Moreover, according to the third embodiment, the pressing/separation mechanism 480 allows the registration roller pair 212 to be pressed together with a relatively small nip load at the time of forcedly opening the nip of the registration roller pair 212 in reconveying the paper P after aligning the paper edge, in which case the load on the registration roller conveyance motor 218 is increased. As a result, an increase in the load torque of the registration roller conveyance motor 218 and the like in forcedly opening the nip can be prevented.

Note that the technical scope of the present invention is not to be limited to the aforementioned embodiments but includes various modifications thereof without departing from the gist of the present invention. While the image forming apparatus 100 in FIG. 1 is adapted to form a color image, for example, the present invention can be applied to not only the image forming apparatus forming the color image but an image forming apparatus forming a monochrome image.

Moreover, while it is determined in the second and third embodiments whether or not the paper P is the thick paper in determining the strength of the nip load of the registration roller pair 212, the determination can also be made on the basis of paper information such as the basis weight and/or size of the paper P, for example.

According to an embodiment of the present invention, the nip load of the resist roller pair at the time of aligning the leading edge of the paper and reconveying the paper is adjusted, whereby the apparatus can support paper such as the thick paper while ensuring the conveying force, holding force and stopping force required of the resist roller pair.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image forming apparatus comprising:
a registration roller pair that conveys paper;
a moving mechanism that moves the registration roller pair in an axial direction orthogonal to a paper conveyance direction while the paper is held between the registration roller pair;
an adjustment unit that adjusts a nip load of the registration roller pair; and
a control unit that controls the adjustment unit, wherein
the control unit controls the adjustment unit to satisfy a relationship of [a nip load of the registration roller pair at the time of paper edge alignment in which a skew of paper is corrected by striking a leading edge of the paper against the registration roller pair]>[a nip load of the registration roller pair at the time of reconveying the paper by the registration roller pair]>0.

2. The image forming apparatus according to claim 1, wherein
the control unit controls the adjustment unit to satisfy a relationship of [the nip load of the registration roller pair at the time of the paper edge alignment in which the skew of the paper is corrected by striking the leading edge of the paper against the registration roller pair]≧[a nip load of the registration roller pair while the registration roller pair moves in the axial direction]>[the nip load of the registration roller pair at the time of reconveying the paper by the registration roller pair]>0.

3. The image forming apparatus according to claim 1, wherein
the control unit controls the adjustment unit to satisfy a relationship of [the nip load of the registration roller pair at the time of the paper edge alignment in which the skew of the paper is corrected by striking the leading edge of the paper against the registration roller pair]≧[a nip load of the registration roller pair while conveying the paper toward a secondary transfer unit]>[the nip load of the registration roller pair at the time of reconveying the paper by the registration roller pair]>0.

4. The image forming apparatus according to claim 1, wherein
the adjustment unit is controlled to satisfy a relationship of [a nip load of the registration roller pair while the registration roller pair moves in the axial direction]≧[a nip load of the registration roller pair while conveying the paper toward a secondary transfer unit]>0.

5. The image forming apparatus according to claim 1, wherein
the registration roller pair includes:
a registration roller that performs rotational driving; and
a driven roller that rotates following rotation of the registration roller, and
the adjustment unit includes a backup member that is configured to be able to abut on and separate from a shaft of the registration roller and adjusts the nip load of the registration roller pair.

6. The image forming apparatus according to claim 5, wherein
the backup member includes:
a bearing that rotatably supports the shaft of the registration roller; and
a cam that is provided to be able to abut on and separate from the bearing and presses the shaft of the registration roller through the bearing.

7. The image forming apparatus according to claim 5, wherein
the registration roller includes:
a shaft; and
a plurality of rollers disposed on the shaft at a predetermined interval, and
the backup member is arranged at a part of the shaft between the rollers adjacent to each other.

8. The image forming apparatus according to claim 1, wherein
the registration roller pair includes:
a registration roller that performs rotational driving; and
a driven roller that rotates following rotation of the registration roller, the adjustment unit includes:
a driven roller holding member that is turnably provided while rotatably supporting the driven roller;
a cam mechanism including a rotatable cam and a cam follower that is movably provided to the driven roller holding member;
a first energizing member that is attached to the driven roller holding member at one end and energizes the driven roller holding member in a manner that the driven roller is pressed against the registration roller; and
a second energizing member that energizes the cam follower toward the cam, and
the control unit adjusts the nip load of the driven roller against the registration roller by causing the cam to press the cam follower, displacing the second energizing member and imparting, to the driven roller holding member, an energizing force directed oppositely to an energizing force by the first energizing member.

9. The image forming apparatus according to claim 8, wherein
the driven roller holding member includes a stopper that regulates a movement of the cam follower, and
the cam follower is pressed by the cam to move relatively to the driven roller holding member until abutting on the stopper and, after abutting on the stopper, causes the driven roller holding member to turn in a manner that the driven roller is separated from the registration roller.

10. The image forming apparatus according to claim 1, wherein
the registration roller pair includes:
a registration roller that performs rotational driving; and
a driven roller that rotates following rotation of the registration roller,
the adjustment unit includes:
a driven roller holding member that is turnably provided while rotatably supporting the driven roller;
a cam mechanism including a rotatable cam and a cam follower that is attached to the driven roller holding member;
an energizing member that is attached to the driven roller holding member at one end and energizes the driven roller holding member in a manner that the driven roller is pressed against the registration roller;
a support member that is rotatably provided while attached to another end of the energizing member; and
a drive unit that rotationally drives the support member, and
the control unit switches the nip load of the registration roller pair by causing the drive unit to rotate the support member and adjusting an energizing force by the energizing member.
